(19) United States
(12) Patent Application Publication
(10) Pub. No.: US 2026/0246519 A1
(43) Pub. Date: Aug. 20, 2026

(54) COMMUNICATION METHODS, APPARATUS, DEVICE, CHIP AND STORAGE MEDIUM

(71) Applicant: GUANGDONG OPPO MOBILE TELECOMMUNICATIONS CORP., LTD., Dongguan (CN)

(72) Inventors: Zhe FU, Dongguan (CN); Rongyi HU, Dongguan (CN); Qianxi LU, Dongguan (CN)

(21) Appl. No.: 19/640,648

(22) Filed: Apr. 7, 2026

Related U.S. Application Data
(63) Continuation of application No. PCT/CN2023/129468, filed on Nov. 2, 2023.

(51) Int. Cl. H04B 7/06; H04W 56/00

(52) U.S. Cl. CPC H04B 7/0626; H04W 56/001

(57) ABSTRACT

Provided are methods of communication. A method includes: obtaining a first timing advance (TA) between a terminal device and a first cell, the first TA being used for the terminal device to perform uplink synchronization with the first cell, the first cell being a secondary cell with no SSB transmission. The method specifies how to perform synchronization between a terminal device and a secondary cell with no SSB transmission.

### CROSS-REFERENCE TO RELATED APPLICATION

This application is a continuation application of International Patent Application No. PCT/CN2023/129468 filed on Nov. 2, 2023, the entire content of which is incorporated herein by reference.

### TECHNICAL FIELD

Embodiments of the present disclosure relate to the technical field of communication, in particular to methods of communication, apparatuses, a device, a chip and a storage medium.

### BACKGROUND

An SSB-less cell is a cell that does not transmit a Synchronization Signal Block (SSB), or is a cell with no SSB transmission. At present, when the SSB-less cell is an SSB-less Secondary Cell (SCell), it is not clear how to perform communication between the terminal device and the SSB-less Secondary Cell.

### SUMMARY

Embodiments of the present disclosure provide methods of communication, apparatuses, a device, a chip, and a storage medium.

According to a first aspect, an embodiment of the present disclosure provides a method of communication, which is applied to a terminal device, and the method includes: obtaining a first timing advance (TA) between the terminal device and a first cell, the first TA being used for the terminal device to perform uplink synchronization with the first cell, the first cell being a secondary cell with no SSB transmission.

According to a second aspect, an embodiment of the present disclosure provides a method of communication, which is applied to a network device, and the method includes: transmitting fourth indication information to a terminal device, the fourth indication information including a first TA between the terminal device and a first cell, and/or a second TA between the terminal device and a second cell, the second cell being a cell for the terminal device to perform uplink synchronization with the first cell, the second TA being used to determine the first TA, and the first TA being used for the terminal device to perform uplink synchronization with the first cell, the first cell being a secondary cell with no SSB transmission.

According to a third aspect, an embodiment of the present disclosure provides a method of communication, which is applied to a terminal device, and the method includes: receiving a reference signal of a second cell or a downlink data signal of a first cell, the reference signal or the downlink data signal being used for the terminal device to perform downlink synchronization or downlink timing with the first cell, the second cell being a cell for the terminal device to perform downlink synchronization or downlink timing with the first cell, and the first cell being a secondary cell with no SSB transmission.

According to a fourth aspect, an embodiment of the present disclosure provides a method of communication, which is applied to a network device, and the method includes: transmitting a reference signal of a second cell or a downlink data signal of a first cell to a terminal device, the reference signal or the downlink data signal being used for the terminal device to perform downlink synchronization or downlink timing with the first cell, the second cell being a cell for the terminal device to perform downlink synchronization or downlink timing with the first cell, and the first cell being a secondary cell with no SSB transmission.

According to a fifth aspect, an embodiment of the present disclosure provides a method of communication, which is applied to a terminal device, and the method includes receiving a first media access control control element (MAC CE) from a network device, the first MAC CE being configured to indicate a reporting manner of a first CSI report having a sub-reporting configuration.

According to a sixth aspect, an embodiment of the present disclosure provides a method of communication, which is applied to a network device, and the method includes: transmitting a first MAC CE to a terminal device, the first MAC CE being configured to indicate a reporting manner of a first CSI report having a sub-reporting configuration.

According to a seventh aspect, an embodiment of the present disclosure provides a method of communication, which is applied to a terminal device, and the method includes: receiving fifth indication information from a network device, the fifth indication information being used to indicate a first operation, or, the fifth indication information being used to indicate the first operation when a third condition is satisfied, the first operation including at least one of the following: a source cell of the terminal device entering network energy-saving (NES); the terminal device performing or starting to perform conditional handover (CHO); and, the terminal device evaluating a CHO execution condition.

According to an eighth aspect, an embodiment of the present disclosure provides a method of communication, which is applied to a network device, and the method includes: transmitting fifth indication information to a terminal device, the fifth indication information being used to indicate a first operation, or the fifth indication information being used to indicate the first operation when a third condition is satisfied, the first operation including at least one of the following: a source cell of the terminal device entering NES; the terminal device performing CHO; the terminal device starting to perform CHO; and, the terminal device evaluating a CHO execution condition.

According to a ninth aspect, an embodiment of the present disclosure provides an apparatus of communication, the apparatus including: a first obtaining unit configured to obtain a first TA between the apparatus and a first cell, the first TA being used for the apparatus to perform uplink synchronization with the first cell, the first cell being a secondary cell with no SSB transmission.

According to a tenth aspect, an embodiment of the present disclosure provides an apparatus of communication, the apparatus including: a first transmitting unit configured to transmit fourth indication information to a terminal device, the fourth indication information including a first TA between the terminal device and a first cell, and/or a second TA between the terminal device and a second cell, the second cell being a cell for the terminal device to perform uplink synchronization with the first cell; the second TA being used to determine the first TA, and the first TA being used for the terminal device to perform uplink synchronization with the first cell, the first cell being a secondary cell with no SSB transmission.

According to an eleventh aspect, an embodiment of the present disclosure provides an apparatus of communication, the apparatus including: a first receiving unit configured to receive a reference signal of a second cell or a downlink data signal of a first cell, and the reference signal or the downlink data signal being used for the apparatus to perform downlink synchronization or downlink timing with the first cell, the second cell being a cell for the apparatus to perform downlink synchronization or downlink timing with the first cell, and the first cell being a secondary cell with no SSB transmission.

According to a twelfth aspect, an embodiment of the present disclosure provides an apparatus of communication, the apparatus including: a second transmitting unit configured to transmit a reference signal of a second cell or a downlink data signal of a first cell to a terminal device, the reference signal or the downlink data signal being used for the terminal device to perform downlink synchronization or downlink timing with the first cell, the second cell being a cell for the terminal device to perform downlink synchronization or downlink timing with the first cell, and the first cell being a secondary cell with no SSB transmission.

According to a thirteenth aspect, an embodiment of the present disclosure provides an apparatus of communication, the apparatus including: a second receiving unit configured to receive a first MAC CE from a network device, the first MAC CE being configured to indicate a reporting manner of a first SCI report having a sub-configuration.

According to a fourteenth aspect, an embodiment of the present disclosure provides an apparatus of communication, the apparatus including: a third transmitting unit configured to transmit a first MAC CE to a terminal device, the first MAC CE being configured to indicate a reporting manner of a first SCI report having a sub-configuration.

According to a fifteenth aspect, an embodiment of the present disclosure provides an apparatus of communication, the apparatus including: a third receiving unit configured to receive fifth indication information from a network device, the fifth indication information being used to indicate a first operation, or the fifth indication information being used to indicate the first operation when a first condition is satisfied, the first operation including at least one of: a source cell of the apparatus entering NES; the apparatus performing or starting to perform CHO; and, the apparatus evaluating a CHO execution condition.

According to a sixteenth aspect, an embodiment of the present disclosure provides an apparatus of communication, the apparatus including: a fourth transmitting unit configured to transmit fifth indication information to a terminal device, the fifth indication information being used to indicate a first operation, or the fifth indication information being used to indicate the first operation when a first condition is satisfied, the first operation including at least one of the following: a source cell of the terminal device entering NES; the terminal device performing or starting to perform CHO; and, the terminal device evaluating a CHO execution condition.

In a seventeenth aspect, an embodiment of the present disclosure provides a communication device, which includes a memory and a processor. The memory is configured to store computer-executable instructions; and the processor coupled to the memory is configured to implement the method of any one of the first to eighth aspects by performing the computer-executable instructions.

According to an eighteenth aspect, an embodiment of the present disclosure provides a chip. The chip includes a processor for calling and running a computer program from a memory to cause a device on which the chip is mounted to perform the method of any one of the first to eighth aspects.

According to a nineteenth aspect, an embodiment of the present disclosure provides a computer-readable storage medium which has stored a computer program thereon that, when executed by at least one processor, implements the method of any one of the first to eighth aspects.

The methods and apparatuses of communication, chip, device, and storage medium provided by the embodiments of the present disclosure describe how to perform synchronization or timing between a terminal device and a secondary cell with no SSB transmission.

### BRIEF DESCRIPTION OF THE DRAWINGS

The accompanying drawings described herein are intended to provide a further understanding of the present disclosure, and constitute a part of the present disclosure. The schematic embodiments of the present disclosure and the description thereof are intended to explain the present disclosure, and do not constitute an undue limitation of the present disclosure. In the drawings:

FIG. 1 is a schematic diagram of an application scenario according to an embodiment of the present disclosure;

FIG. 2 is a schematic flow diagram of a method of communication according to an embodiment of the present disclosure;

FIG. 3 is a second schematic flow diagram of a method of communication according to an embodiment of the present disclosure;

FIG. 4 is a third schematic flow diagram of a method of communication according to an embodiment of the present disclosure;

FIG. 5 is a schematic flow diagram of a method of communication according to an embodiment of the present disclosure;

FIG. 6 is a schematic structural diagram of an apparatus of communication according to an embodiment of the present disclosure;

FIG. 7 is a second schematic structural diagram of an apparatus of communication according to an embodiment of the present disclosure;

FIG. 8 is a third schematic structural diagram of an apparatus of communication according to an embodiment of the present disclosure;

FIG. 9 is a fourth schematic structural diagram of an apparatus of communication according to an embodiment of the present disclosure;

FIG. 10 is a fifth schematic structural diagram of an apparatus of communication according to an embodiment of the present disclosure;

FIG. 11 is a sixth schematic structural diagram of an apparatus of communication according to an embodiment of the present disclosure;

FIG. 12 is a seventh schematic structural diagram of an apparatus of communication according to an embodiment of the present disclosure;

FIG. 13 is an eighth schematic structural diagram of an apparatus of communication according to an embodiment of the present disclosure;

FIG. 14 is a schematic structural diagram of a communication device according to an embodiment of the present disclosure;

FIG. 15 is a schematic structural diagram of a chip according to an embodiment of the present disclosure; and

FIG. 16 is a schematic block diagram of a communication system according to an embodiment of the present disclosure.

### DETAILED DESCRIPTION

Hereinafter, the technical solutions in the embodiments of the present disclosure will be described with reference to the accompanying drawings in the embodiments of the present disclosure. The described embodiments are part of the embodiments of the present disclosure, but not all the embodiments. Based on the embodiments in the present disclosure, all other embodiments obtained by those skilled in the art without creative work shall fall within the scope of protection of the present disclosure.

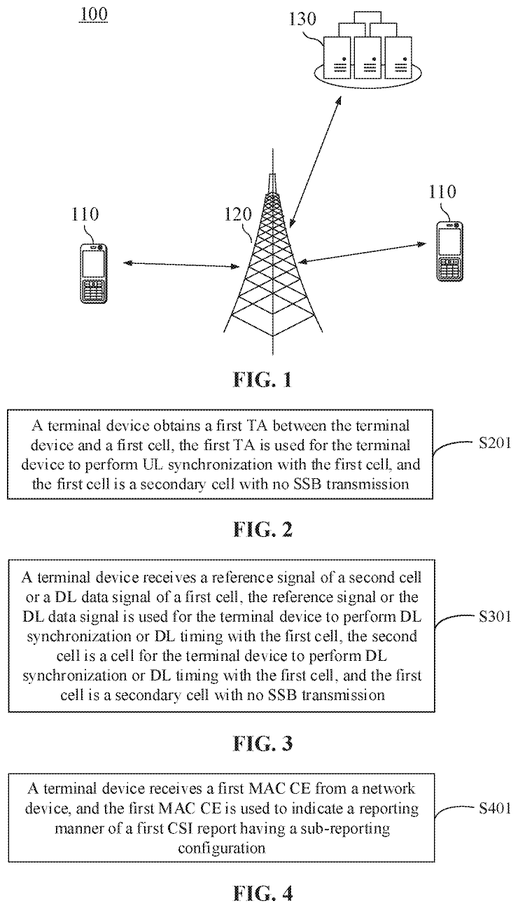

FIG. 1 is a schematic diagram of an application scenario according to an embodiment of the present disclosure.

As shown in FIG. 1, a communication system 100 may include a terminal device 110 and a network device 120. The network device 120 may communicate with the terminal device 110 through an air interface. Multi-service transmission is supported between the terminal device 110 and the network device 120.

It should be understood that the embodiments of the present disclosure are only illustrated with reference to the communication system 100, but the embodiments of the present disclosure are not limited thereto. That is, the technical solution of the embodiments of the present disclosure can be applied to various communication systems, such as a Long Term Evolution (LTE) system, an LTE Time Division Duplex (TDD), a Universal Mobile Telecommunication System (UMTS), an Internet of Things (IoT) system, and a Narrow Band Internet of Things (NB-IoT) system, an enhanced Machine-Type Communications (eMTC) system, a 5G communication system (also referred to as a New Radio (NR) communication system), a B5G communication system, a 6G communication system, or a future communication system, etc.

In the communication system 100 shown in FIG. 1, the network device 120 may be an access network device that communicates with the terminal device 110. An access network device may provide communication coverage for a particular geographic area and may communicate with a terminal device 110 (e.g., UE) located within that coverage area.

The network device 120 may be an evolutional Node B (eNB, or eNodeB) in a Long Term Evolution (LTE) system, or a Next Generation Radio Access Network (NG RAN) device, or a base station (gNB) in an NR system, or a radio controller in a Cloud Radio Access Network (CRAN), or a relay station, an access point, an in-vehicle device, a wearable device, a hub, a switch, a bridge, a router, or a network device in a future evolved Public Land Mobile Network (PLMN).

The terminal device 110 may be any terminal device including, but not limited to, terminal devices connected with the network device 120 or with other terminal devices using wired or wireless connections.

For example, the terminal device 110 may refer to an access terminal, a User Equipment (UE), a subscriber unit, a subscriber station, a mobile station, a mobile site, a remote station, a remote terminal, a mobile device, a user terminal, a terminal, a wireless communication device, a user agent, or a user apparatus. The access terminal may be a cellular telephone, a cordless telephone, a Session Initiation Protocol (SIP) telephone, an IoT device, a satellite handheld terminal, a Wireless Local Loop (WLL) station, a Personal Digital Assistant (PDA), a handheld device with wireless communication functionality, a computing device or other processing device connected to a wireless modem, a vehicle-mounted device, a wearable device, a terminal device in a 5G network or a terminal device in a future evolution network, or the like.

The terminal device 110 may be used for device-to-device (D2D) communication.

The wireless communication system 100 may further include a core network device 130 that communicates with the network device 120. The core network device 130 may be a 5G Core (5GC) device, for example, an Access and Mobility Management Function (AMF), for another example, an Authentication Server Function (AUSF), for another example, a User Plane Function (UPF), for another example, a Session Management Function (SMF). In some embodiments, the core network device 130 may also be an Evolved Packet Core (EPC) device of an LTE network, e.g., a Session Management Function+Core Packet Gateway (SMF+PGW-C) device. It should be understood that the SMF+PGW-C can simultaneously implement functions that the SMF and PGW-C can implement. In the process of network evolution, the core network devices may be called by other names, or may form new network entities by dividing the functions of the core network, which is not limited by the embodiments of the present disclosure.

The respective functional units in the communication system 100 may also establish a connection between each other through a next generation network (NG) interface to achieve communication.

For example, the terminal device establishes an air interface connection with an access network device through an NR interface for transmitting user plane data and control plane signaling; the terminal device may establish a control plane signaling connection with an AMF through NG interface 1 (N1 for short); the access network device, such as a next generation radio access base station (gNB), may establish a user plane data connection with a UPF through NG interface 3 (N3 for short); the access network device may establish a control plane signaling connection with the AMF through NG interface 2 (N2 for short); the UPF may establish a control plane signaling connection with an SMF through NG interface 4 (N4 for short); the UPF may interchange user plane data with a data network through NG interface 6 (N6 for short); the AMF may establish a control plane signaling connection with the SMF through NG interface 11 (N11 for short); the SMF may establish a control plane signaling connection with a PCF through NG interface 7 (N7 for short).

FIG. 1 exemplarily illustrates one network device, one core network device, and two terminal devices. Optionally, the wireless communication system 100 may include a plurality of network devices and another number of terminal devices may be included within the coverage range of each network device, which is not limited by the embodiments of the present disclosure.

It should be noted that FIG. 1 only illustrates a system applicable to the present disclosure as an example, and the method shown in the embodiment of the present disclosure may also be applied to other systems. Further, the terms “system” and “network” are often used interchangeably herein. The term “and/or” describes only an association relationship between associated objects, and means that there may be three relationships, for example, A and/or B, which may mean that A alone is present, A and B simultaneously exist, and B alone is present. In addition, the character “/” herein generally indicates that the related objects before and after are in an “or” relationship. It should also be understood that the “indication” mentioned in the embodiments of the present disclosure may mean a direct indication, an indirect indication, or an associated relationship. For example, A indicates B, which may mean that A directly indicates B, for example, B can be acquired by A; or mean that A indicates B indirectly, for example A indicates C, and B can be acquired through C; or mean that there is an association relationship between A and B. It should also be understood that “correspond” mentioned in the embodiments of the present disclosure may indicate that there is a direct correspondence or indirect correspondence between the two, or may indicate that there is a correlation relationship between the two, or may indicate a relationship between indicating and being indicated, configuring and being configured, or the like. It should also be understood that the “predefined” or “predefined rules” mentioned in the embodiments of the present disclosure may be implemented by storing corresponding codes, tables in advance in devices (e.g., including terminal devices and network devices) or by other ways that may be used to indicate relevant information, and the specific implementations thereof is not limited in the present disclosure. For example, “predefined” may refer to being defined in a protocol. It should also be understood that in the embodiments of the present disclosure, the “protocol” may refer to a standard protocol in the field of communication, and may include, for example, an LTE protocol, an NR protocol, and related protocols applied to future communication systems, which is not limited in the present disclosure.

In order to facilitate understanding of the technical solutions of the embodiments of the present disclosure, the related technologies of the embodiments of the present disclosure will be described below, and the related technologies below can be arbitrarily combined with the technical solutions of the embodiments of the present disclosure as options, and all of them belong to the scope of protection of the embodiments of the present disclosure.

### 1. Main Application Scenarios of 5G

With people's pursuit of speed, latency, high-speed mobility, energy efficiency, and the diversity and complexity of services in future life, the 3rd Generation Partnership Project (3GPP) international standards organization has begun to develop 5G. The main application scenarios of 5G are: enhanced mobile ultra-wideband (eMBB), Ultra-Reliable Low-Latency Communications (URLLC), and massive Machine-Type Communications (mMTC).

On the one hand, eMBB still aims at users' access to multimedia content, services and data, and its demand is growing rapidly. On the other hand, since eMBB may be deployed in different scenarios, such as indoors, urban areas, rural areas, etc., its capabilities and needs are quite different, so it cannot be generalized and should be analyzed in detail based on specific deployment scenarios. Typical applications of URLLC include: industrial automation, power automation, telemedicine operations (surgery), traffic safety and security, etc. The typical characteristics of mMTC include: high connection density, small data volume, delay-insensitive services, low cost and long service life of modules, etc.

### 2. Radio Resource Control (RRC) State in 5G Network Environment

NR may be deployed independently. In order to achieve the purpose of reducing air interface signaling, quickly restoring wireless connections and quickly restoring data services in the 5G network environment, a new RRC state is defined, namely the RRC_INACTIVE state. This state is different from the RRC IDLE (RRC IDLE) state and the RRC ACTIVE (RRC_ACTIVE) state. Three RRC states in the 5G network environment are described below:
1) RRC_IDLE state: Mobility is UE-based cell selection and reselection, paging is initiated by a Core Network (CN), and the paging area is configured by the CN. There is no UE Access Stratum (AS) context on the base station side, and there is no RRC connection.
2) RRC_CONNECTED state: There is an RRC connection, and a base station and UE have UE AS context. The network side knows that the location of the UE is at a specific-cell level. Mobility is the one controlled by the network side. Unicast data may be transmitted between the UE and the base station.
3) RRC_INACTIVE state: Mobility is cell selection and reselection based on UE, there is a connection between CN-NR, UE AS context is present on a certain base station, paging is triggered by a Radio Access Network (RAN), and the RAN-based paging area is managed by the RAN, and the network side knows that the location of UE is at a RAN-based-paging-area level.

### 3. Network Energy-Saving (NES) Projects

Energy consumption has become a significant part of operators' operating costs. According to the report, the energy cost of mobile networks accounts for about 23% of the operator's total cost. Most of the energy consumption comes from radio access networks, especially from active antenna units (AAU), while data centers and optical fiber transmissions only account for a small share. Power consumption includes two types:
1) Dynamic part: such as consumption during data transmission/reception
2) Static part: such as consumption for maintaining the necessary operations of radio access devices, even if there is no continuous data transmission/reception at this time.

The study should not only evaluate the potential network energy consumption gains, but also evaluate and balance the impact on network and user performance. For example, this study should not have a particularly large impact on some key performance indicators (KPIs), such as: spectral efficiency, capacity, User Packet Throughput (UPT), latency, UE power consumption, complexity, Handover performance, call drop rate, initial access performance, etc.

### 4. SSB-Less Cell

An SCell may be a cell that does not transmit an SSB, and this cell and a Special Cell (SpCell) or other SCells are intra-band cells. As an SSB-less SCell, UE synchronizes with it, currently through a SpCell or another SCell.

In the network energy saving project, it is considered to extend the intra-band scenario to the inter-band scenario, that is, the SSB-less SCell is an inter-band cell with respect to a Primary Cell (PCell) or another SCell. Possible scenarios are as follows:
Scenario 1: SCell has no SSB transmission, and has Tracking Reference Signal (TRS) transmission.
Scenario 2a: SCell has no SSB transmission or any other Downlink (DL) transmission, and has Uplink (UL) reception on the network (NW) side.
Scenario 2: SCell has no SSB transmission and no TRS transmission.

The scenario 1 is supported by R18. The scenario 2a is a scenario not supported by R18, but possibly supported by R19. For the scenario 1, how to implement DL synchronization, the conclusion of R4 is as follows. However, no conclusion has been made for the scenario 2a. Conclusions for the scenario 1 include:

To implement the SSB-less SCell operation, RAN 4 agrees to introduce an indication from a NW to UE to indicate which cell is a reference cell. If no indication is provided, RAN 4 defines a “by default cell” as the reference cell. The reference cell means that it is a timing reference and an Automatic Gain Control (AGC) source of the SSB-less SCell. If the reference cell is an SCell or a Primary Secondary Cell (PSCell), it should be an active SCell or an active PSCell. RAN4 also reached an agreement on SSB-less SCell. If UE is not provided with an SSB configuration (absoluteFrequencySSB) in an SCell (FrequencyInfoDL), nor is provided with an SS/PBCH block measurement timing configuration (SMTC) for the SCell, the cell is considered as an SSB-less SCell.

The related technologies/terms related to the present disclosure have been briefly described above, and will not be repeatedly described in the following examples.

In the related art, an SSB-less cell may be used as an Scell or an independently operating cell. When the SSB-less cell is an SSB-less SCell, how a terminal device and the SSB-less SCell work, such as synchronization, is an urgent problem to be solved.

In view of this, the present disclosure provides a method of communication in which a terminal device may obtain a Timing Advance (TA) between the terminal device and a first cell, and the first TA may be used for the terminal device to perform uplink synchronization with the first cell. The first cell is a secondary cell with no SSB transmission (i.e., an SSB-less SCell).

In the embodiments of the present disclosure, “TA” may be replaced with “TA amount” or “UL timing synchronization”. “Perform uplink synchronization” may also be replaced with “perform TA” or “perform UL timing”.

It should be noted that the “first TA between the terminal device and a first cell” mentioned in the embodiments of the present disclosure may also be simply referred to as “TA of the first cell”; The “second TA between the terminal device and a second cell” mentioned in the embodiments of the present disclosure may also be simply referred to as “TA of the second cell”.

In order to facilitate understanding of the technical solutions of the embodiments of the present disclosure, the technical solutions of the present disclosure will be described in detail below with reference to specific examples. As an optional solution, the above related technologies can be arbitrarily combined with the technical solutions of the embodiments of the present disclosure, and all of them belong to the scope of protection of the embodiments of the present disclosure. Embodiments of the present disclosure include at least some of the following.

FIG. 2 illustrates a method of communication according to an embodiment of the present disclosure, and the method may include:

S201, a terminal device obtains a first TA between the terminal device and a first cell, the first TA is used for the terminal device to perform UL synchronization with the first cell, and the first cell is a secondary cell with no SSB transmission.

In this embodiment, the terminal device may obtain the first TA between the terminal device and the first cell, and may further perform UL synchronization with the first cell based on the first TA.

As an example, several possible implementations in which the terminal device obtains the first TA are described below.

In a first possible implementation, the first TA may be included in first indication information from a network device. The first indication information is a response to first request information for requesting for the first TA, or the first request information is request information for requesting for the first TA transmitted by the terminal device to the network device.

Exemplarily, the first indication information may be, for example, any of the following: a Random Access Response (RAR); Timing Advance Command (TAC) Media Access Control Element (MAC CE); and a DL message carrying the first TA. Here, the DL message carrying the first TA may be, for example, some kind of DL message other than the RAR and the TAC MAC CE.

Exemplarily, the first request information may be, for example, any of: a Scheduling Request (SR) (or a dedicated SR); Uplink Control Information (UCI) (or dedicated UCI); a UL MAC CE (which may be carried via PUSCH); a UL Radio Resource Control (RRC) message (which may be carried via PUSCH); a UL resource of the first cell; and a UL resource of a second cell. Here, the UL resource may refer to, for example, a PUSCH at a specific time-frequency location.

In this embodiment, the second cell is a cell for the terminal device to perform UL synchronization with the first cell. Here, the second cell is a cell for the terminal device to perform UL synchronization with the first cell, or it may be further understood that the TA of the second cell may be used to determine the TA of the first cell (that is, the second TA may be used to determine the first TA), or it may be further understood that the second cell is a cell having the same or similar TA as the first cell (that is, the second TA is the same or similar to the first TA).

According to the above technical solution, the terminal device may request the network device to transmit the first TA by transmitting the first request information to the network device, and thus, the network device may carry the first TA in the first indication information based on the first request information from the terminal device, and transmit the first TA to the terminal device.

In some embodiments, the first indication information may also carry a second TA which may be used to determine the first TA. In this way, after receiving the first indication information from the network device, the terminal device may perform UL synchronization with the first cell based on the first TA carried in the first indication information, or may determine the first TA based on the second TA carried in the first indication information, and further perform UL synchronization with the first cell based on the determined first TA.

In some embodiments, the first indication information may carry the second TA without carrying the first TA. That is, after receiving the first request information for requesting for the first TA from the terminal device, the network device may carry the second TA in the first indication information and transmit it to the terminal device. In this case, the terminal device may determine the first TA based on the second TA included in the first indication information, and further perform UL synchronization with the first cell based on the determined first TA.

In a second possible implementation, the first TA may be obtained through a Random Access (RA) procedure (e.g. referred to as the first RA procedure). The first RA procedure is performed by the terminal device in the first cell or a second cell.

In some embodiments, before the terminal device performs the first RA procedure, the method may further include: the terminal device obtains configuration information of a first reference signal, the first reference signal being a reference signal of the first cell or a reference signal of the second cell, and the first reference signal is used to perform the first RA procedure.

Exemplarily, the terminal device may obtain configuration information of the first reference signal as follows.

In an example, before the terminal device performs the first RA procedure, the network device may transmit configuration information of the first reference signal to the terminal device, and correspondingly, the terminal device may receive the configuration information of the first reference signal from the network device. In another example, before the terminal device performs the first RA procedure, the terminal device may read the configuration information of the first reference signal from the first cell or the second cell. For example, the terminal device may read the configuration information of the reference signal of the first cell from the first cell. For another example, the terminal device may read the configuration information of the reference signal of the second cell from the second cell. In yet another example, before the terminal device performs the first RA procedure, the network device may transmit at least a part of the configuration information of the first reference signal to the terminal device, in which case the terminal device may read the remaining at least part of the configuration information of the first reference signal from the first cell or the second cell

For example, the type of the reference signal of the first cell may be, for example, a TRS or a Channel State Information Reference Signal (CSI-RS); and the type of the reference signal of the second cell may be, for example, any one of SSB, TRS, and CSI-RS.

According to the above-described technical solution, the terminal device may acquire configuration information of the first reference signal, and further, the terminal device may perform the first RA procedure in the first cell or the second cell based on the first reference signal configured by the configuration information. For example, after acquiring the configuration information of the first reference signal, the terminal device may determine a preamble and/or an RO corresponding to the first reference signal, thereby performing the first RA procedure based on the determined preamble and/or RO.

Through the first RA procedure, the terminal device may obtain the first TA. For example, in the first RA procedure, the network device may transmit the first TA carried in an RAR to the terminal device. In some embodiments, the network device may also transmit the second TA carried in an RAR to the terminal device. In this way, after receiving the RAR, the terminal device may perform UL synchronization with the first cell based on the first TA carried in the RAR, or may determine the first TA based on the second TA carried in the RAR, and further perform UL synchronization with the first cell based on the determined first TA. In some embodiments, the RAR may carry the second TA in the RAR without carrying the first TA. In this way, after receiving the RAR, the terminal device may determine the first TA based on the second TA carried in the RAR, and then perform UL synchronization with the first cell based on the determined first TA.

In some embodiments, the type of the reference signal used to perform the first RA procedure may be indicated by the network device. That is, the type of the first reference signal used by the terminal device in the first RA procedure is indicated by the network device. In other words, the network device may indicate to the terminal device which reference signal is used to perform the first RA procedure. For example, the network device may indicate to the terminal device whether the first RA procedure is performed using an SSB, a TRS, or a CSI-RS.

In a third possible implementation, the first TA may be determined based on a UL data signal of the first cell. That is, the terminal device may acquire the first TA based on the UL data signal of the first cell, and further perform UL synchronization with the first cell based on the first TA.

In a fourth possible implementation, the first TA may be determined based on the second TA between the terminal device and the second cell. For example, the terminal device may acquire the second TA, and further determine the first TA based on the acquired second TA.

In an example, the first TA is equal to the second TA, i.e., the second cell has the same TA as the first cell. In this case, the terminal device may use the second TA as the first TA, that is, the terminal device may perform UL synchronization with the first cell based on the second TA.

In another example, the second cell has a similar TA to the first cell. In this case, the terminal device may derive the first TA based on the second TA. For example, an offset may be added/subtracted/multiplied/divided on the basis of the second TA to obtain the first TA. For another example, the first TA is a result of a function whose input includes the second TA, e.g., first TA=f (second TA).

As an example, several possible implementations in which the terminal device obtains the second TA are described below.

In a first possible manner, the second TA may be included in second indication information from the network device. The second indication information is a response to second request information for requesting for the second TA, or the second request information is request information for requesting for the second TA transmitted by the terminal device to the network device.

Exemplarily, the second indication information may be, for example, any of the following: an RAR; a TAC MAC CE; and a DL message carrying the second TA. Here, the DL message carrying the second TA may be, for example, some kind of DL message other than the RAR and the TAC MAC CE.

Exemplarily, the second request information may be, for example, any of the following: an SR (or a dedicated SR); UCI (or dedicated UCI); a UL MAC CE (which may be carried via a PUSCH); a UL RRC message (which may be carried via a PUSCH); a UL resource of the first cell; and a UL resource of the second cell. Here, the UL resource may refer to, for example, a PUSCH at a specific time-frequency location.

According to the above technical solution, the terminal device may request the network device to transmit the second TA by transmitting the second request information to the network device, and thus, the network device may carry the second TA in the first indication information based on the second request information from the terminal device, and transmit the second TA to the terminal device.

In some embodiments, the second indication information may further carry the first TA. In this way, after receiving the second indication information from the network device, the terminal device may perform UL synchronization with the first cell based on the first TA carried in the second indication information, or may determine the first TA based on the second TA carried in the second indication information, and further perform UL synchronization with the first cell based on the determined first TA.

In some embodiments, the second indication information may carry the first TA without carrying the second TA. That is, after receiving the second request information for requesting for the second TA from the terminal device, the network device may carry the first TA in the first indication information and transmit it to the terminal device. In this case, the terminal device may perform UL synchronization with the first cell based on the first TA carried in the second indication information.

In a second possible manner, the second TA may be obtained by a RA procedure (e.g. referred to as a second RA procedure). The second RA procedure is performed by the terminal device in the first cell or the second cell.

In some embodiments, before the terminal device performs the second RA procedure, the method may further include: the terminal device obtains configuration information of a first reference signal, the first reference signal being a reference signal of the first cell or a reference signal of the second cell, and the first reference signal is used to perform the second RA procedure.

The above description of the first RA procedure describe the method in which the terminal device obtains the configuration information of the first reference signal, the type of the reference signal of the first cell, and the type of the reference signal of the second cell, and will not be repeatedly described here.

According to the above-described technical solution, the terminal device may acquire configuration information of the first reference signal, and further, the terminal device may perform the second RA procedure in the first cell or the second cell based on the first reference signal configured by the configuration information. For example, after acquiring the configuration information of the first reference signal, the terminal device may determine a preamble and/or an RO corresponding to the first reference signal, thereby performing the second RA procedure based on the determined preamble and/or RO.

Through the second RA procedure, the terminal device may obtain the second TA. For example, in the second RA procedure, the network device may transmit the second TA carried in an RAR to the terminal device. In some embodiments, the network device may also transmit the first TA carried in an RAR to the terminal device. In this way, after receiving the RAR, the terminal device may perform UL synchronization with the first cell based on the first TA carried in the RAR, or may determine the first TA based on the second TA carried in the RAR, and further perform UL synchronization with the first cell based on the determined first TA. In some embodiments, the first TA may be carried in the RAR without carrying the second TA. In this way, after receiving the RAR, the terminal device may perform UL synchronization with the first cell based on the first TA carried in the RAR.

In some embodiments, the type of the reference signal used to perform the second RA procedure may be indicated by the network device. That is, the type of the first reference signal used by the terminal device in the second RA procedure is indicated by the network device. In other words, the network device may indicate to the terminal device which reference signal is used to perform the second RA procedure. For example, the network device may indicate to the terminal device whether the second RA procedure is performed using an SSB, a TRS, or a CSI-RS.

In some embodiments, the network device may transmit the first TA and/or the second TA carried in fourth indication information to the terminal device. The second TA is used to determine the first TA, and the first TA is used for the terminal device to perform UL synchronization with the first cell.

As an example, the fourth indication information is the first indication information or the second indication information.

As another example, the fourth indication information is a response to third request information for requesting for the first TA and/or the second TA, or the third request information is request information for requesting for the first TA and/or the second TA transmitted by the terminal device to the network device.

Exemplarily, the fourth indication information may be, for example, any of the following: an RAR; a TAC MAC CE; and a DL message carrying the first TA and/or the second TA. The DL message carrying the first TA and/or the second TA may be, for example, some kind of DL message other than the RAR and the TAC MAC CE.

Exemplarily, the third request information may be, for example, any of the following: an SR (or a dedicated SR); UCI (or dedicated UCI); a UL MAC CE (which may be carried via PUSCH); a UL RRC message (which may be carried via PUSCH); a UL resource of the first cell; and a UL resource of the second cell. Here, the UL resource may refer to, for example, a PUSCH at a specific time-frequency location.

As yet another example, the fourth indication information is an RAR transmitted by the network device to the terminal device in the RA procedure. The RA procedure may be, for example, the first RA procedure or the second RA procedure described above. That is, the fourth indication information may be an RAR transmitted by the network device to the terminal device in the first RA procedure. Alternatively, the fourth indication information may be an RAR transmitted by the network device to the terminal device in the second RA procedure.

Hereinafter, the second cell in the embodiments will be described.

In some embodiments, the second cell may be indicated by the network device, or the second cell may be preconfigured by the terminal device, or the second cell may be preconfigured by the network device, or the second cell may be predefined (as predefined by the protocol), or the second cell may be determined/selected by the terminal device. In other words, which cell is the cell for the terminal device to perform UL synchronization with the first cell (or which cell's TA may be used to determine the TA of the first cell, or which cell has the same or similar TA as the first cell) is indicated by the network device, or is preconfigured by the terminal device or the network device, or is predefined (as predefined by the protocol), or is determined/selected by the terminal device.

According to the above-described technical solution, the method for determining the second cell is described, that is, which cell may be used for the terminal device to perform UL synchronization with the first cell is described.

In some embodiments, the second cell may be determined/selected based on first information. For example, the second cell may be determined/selected by the terminal device based on the first information transmitted by the network device. The first information may include, for example, at least one of: location information of the network device; location information of a neighboring network device of the network device (i.e., a network device adjacent to the network device); location information of a third cell included in the network device, wherein the third cell is a cell where the terminal device is located; location information of a cell adjacent to the third cell; co-located information between network devices; co-located information between cells; Quasi Co-Location (QCL) information between reference signals; QCL information between channels; and positioning information.

Taking the network device as a base station as an example, the first information may include, for example, at least one of the following: location information of the base station (i.e., location information of the network device); location information of a neighboring base station (i.e., location information of a neighboring network device of the network device); location information of the cell/local cell in which the terminal device is located (i.e., location information of the third cell included in the network device); location information of a neighboring cell (i.e., location information of a cell adjacent to the third cell); information of base stations which are co-located base stations (i.e. co-location information between network devices); information of cells which are co-located cells (i.e., co-located information between cells); QCL information between reference signals; QCL information between channels; and positioning information.

For example, the second cell may be, for example, any of the following cells: a PCell; a PSCell; a PCell or PSCell in the same cell group as the first cell; any cell in the same cell group as the first cell; a cell having the smallest cell index in the same cell group as the first cell; a cell having the largest cell index in the same cell group as the first cell; any cell in the same TA group as the first cell; a cell having the smallest cell index in the same TA group as the first cell; and a cell with the largest cell index in the same TA group as the first cell.

In some embodiments, the second cell may be indicated by the network device through third indication information. For example, the network device may transmit the third indication information to the terminal device, and correspondingly, the terminal device may receive the third indication information from the network device, so that the terminal device may know that the second cell is a cell for the terminal device to perform UL synchronization with the first cell based on the third indication information.

Exemplarily, the third indication information may include, for example, a frequency point and/or a cell identity of the second cell. The frequency point may be a frequency point index, such as an index among adjacent frequency points in SIB3/4/5, or a frequency point index (frequency point index of a serving cell) of SIB2. Alternatively, the frequency point may be a frequency point value (ARFCN−ValueNR), or the frequency point may be a frequency point value corresponding to SIB2 (a frequency point value of a serving cell). The cell identity may be, for example, a Physical Cell Identity (PCI) or a global cell identity. In some embodiments, a frequency point value may be provided using absoluteFrequencySSB, or other IE. In some embodiments, when a frequency point value may be provided using absoluteFrequencySSB, the frequency point may be the frequency point of a current serving cell, or the frequency point of a reference cell or a downlink timing acquisition cell (for example, when the SSB-less SCell acquires downlink timing from another cell, the frequency point of said another cell or the frequency point of the SSB of said another cell is given).

In some embodiments, the third indication information may be configured under a first condition. The first condition may include, for example, at least one of the following: a condition of SCellAdd; a condition of SCellAddMod; a condition of SCellOnly; and a condition of SCelladdOnly. That is, the third indication information may be configured under at least one of: the condition of SCellAdd, the condition of SCellAddMod, the condition of SCellOnly, and the condition of SCelladdOnly. As an embodiment, the third indication information may be configured under the condition of SCellAdd, or may be configured under the condition of SCellAddMod, or may be configured under the condition of SCellOnly, or may be configured under the condition of SCelladdOnly. A description of the above conditions can be found in Table 1 below.

In some embodiments, if the third indication information is present, or if the network device transmits the third indication information to the terminal device, the terminal device may perform UL synchronization with the first cell based on the second cell indicated by the third indication information. If the third indication information is absent, or if the network device does not transmit the third indication information to the terminal device, the terminal device may use a default cell as the second cell, and perform UL synchronization with the first cell based on the default cell; or the terminal device may autonomously determine/select a cell as the second cell, and perform UL synchronization with the first cell based on the determined/selected cell.

In some embodiments, the first cell belongs to the same TA group and/or cell group as the second cell. The TAs of the respective cells belonging to the same TA group are the same, and there is an association relationship between the TAs of the respective cells belonging to the same cell group, so that when the first cell and the second cell belong to the same TA group and/or cell group, the second TA may be used to determine the first TA.

In a possible manner, the TA group and/or cell group may be determined by the network device based on the second information. Exemplarily, the second information may include, for example, at least one of: a measurement result of the reference signal; positioning information (e.g., location information of a terminal device and/or location information of a network device adjacent to the terminal device); motion trajectory information of the terminal device; location information of the network device; location information of a neighboring network device of the network device; location information of a third cell included in the network device, wherein the third cell is a cell where the terminal device is located; location information of a cell adjacent to the third cell; co-located information between network devices; and co-located information between the respective cells.

Here, at least one of the measurement result of the reference signal, the positioning information, and the motion trajectory information of the terminal device may be, for example, transmitted by the terminal device to the network device. That is, the terminal device may transmit at least one piece of information among the measurement result of the reference signal, the positioning information, and the motion trajectory information of the terminal device to the network device for determining the TA group and/or the cell group by the network device.

In some embodiments, the second cell is activated by the terminal device as instructed by the network device, or the second cell is activated by the terminal device under the second condition.

In a possible case, the second cell is activated by the terminal device as instructed by the network device. In an example, the network device may instruct the terminal device to activate the second cell through RRC configuration. For example, the network device may set scellState in the RRC configuration (as in SCellConfig) to activated so as to indicate activation of the second cell. As another example, the network device may use MAC CE (such as SCell Activation/Deactivation MAC CE, enhanced Sell Activation/Deactivation MAC CE, Or a new SCell activation/deactivation MAC CE) to instruct the terminal device to activate the second cell.

Another possible scenario is that the second cell is activated by the terminal device under a second condition.

Exemplarily, the second condition may include, for example, at least one of the following: a deactivation timer of the second cell timing out; the deactivation timer of the second cell needing to be started; the deactivation timer of the second cell needing to be restarted; the terminal device obtaining indication information for indicating the second cell; the terminal device obtaining a reference signal of the second cell; the terminal device performing uplink synchronization or downlink synchronization with the first cell; the terminal device obtaining a configuration of the first cell; the first cell being activated; and, the first cell needing to be activated.

According to the method of this embodiment, it is described how the terminal device performs UL synchronization with the first cell (SSB-less Scell).

In order to facilitate understanding of the embodiments of the present disclosure, possible implementation schemes (including schemes 2A to 2C) applicable for the method shown in FIG. 2 will be described below with reference to examples. The schemes 2a to 2C may for example be directed to the aforementioned scenario 2a.

### Scheme 2A

In Scheme 2A, a network (network device) may configure a SSB-less SCell (an example of the first cell) to belong to the same cell group and/or TA group as a specific cell (an example of the second cell). In this embodiment, the specific cell is a cell for UE to perform uplink synchronization with the SSB-less SCell, or the specific cell may be understood as a cell having the same/similar TA as the SSB-less SCell. The TA between the UE and the specific cell (corresponding to the second TA in the foregoing embodiment) may be used to determine the TA between the UE and the SSB-less SCell (corresponding to the first TA in the foregoing embodiment). In this embodiment, the specific cell may be, for example, a reference cell, or the specific cell may be replaced with a reference cell.

For example, if the UE knows which cell the specific cell is (e.g., knows the cell identity, frequency point, etc. of the specific cell), the UE may consider the UL timing synchronization (or TA) between the UE and the specific cell is the same/similar to the UL timing synchronization (or TA) between the UE and the SSB-less SCell. In this case, the UE may determine the TA between the UE and the SSB-less SCell based on the TA between the UE and the specific cell, and then perform UL synchronization with the SSB-less SCell.

In some embodiments, the UE may report at least one of the following information to the network for configuring a cell of a cell group or a TA group: a measurement result of the reference signal, positioning information (such as the location of the UE and/or the location of a base station adjacent to the UE), and motion trajectory information of the UE.

In some embodiments, in addition to being indicated to the UE by the network, which cell a specific cell is, or which cell belongs to the same cell group and/or TA group as the SSB-less SCell, or the TA of which cell may be used by the UE to determine the TA between the UE and the SSB-less SCell, may be determined by any of the following methods: pre-configured to the UE; determined/selected by the UE itself; and predefined (e.g. predefined by protocol). For example, the specific cell may be, for example, any one of: a PCell in the same cell group as an SSB-less SCell, a PSCell, a cell having the smallest cell index, or a cell having the largest cell index.

Exemplarily, the network may, for example, indicate auxiliary information (corresponding to the first information in the foregoing embodiments) to the UE for the UE to determine/select the specific cell, or for the UE to determine a cell having the same/similar TA as the SSB-less SCell. Here, the auxiliary information may include, for example, at least one of the following: location information of a local base station (the local network/network device), location information of a neighboring base station (the neighboring network/network device of the local network/network device); location information of a local area (the cell where the UE is located); location information of a neighboring cell (a neighboring cell of the cell in which the UE is located); information of base stations which are co-located with the local base station (or co-located information between base stations); information of cells which are co-located cells; information of base stations which are co-located base stations; QCL information between reference signals; QCL information between channels; and positioning information.

For example, the UE may autonomously determine/select a specific cell based on some preset criteria, or autonomously determine/select a cell having the same/similar TA as the SSB-less SCell. In an example, the UE may determine/select a specific cell based on at least one of the following information: cell identity, location information of the UE, location information of network (which may include, for example, cell coverage information, Quasi-Co-Location (QCL) information), positioning information, and co-located information. In another example, the UE may determine/select a specific cell by determining a threshold value. For example, if the distance between the UE and a certain cell is less than a preset threshold, the cell may be determined/selected as a specific cell. For another example, assuming that the distance between the UE and the SSB-less SCell is d1, and the distance between the UE and another cell is d2, if the difference between d1 and d2 is less than a preset threshold, said another cell may be determined as a specific cell.

In a possible case, the TA between the UE and the SSB-less SCell is equal to the TA between the UE and the specific cell, that is, the specific cell and the SSB-less SCell have the same TA, and in this case, when the UE performs UL synchronization with the SSB-less SCell based on the TA of the specific cell, the TA between the UE and the specific cell may be used as the TA between the UE and the SSB-less SCell.

In another possible case, the specific cell and the SSB-less SCell have a similar TA, and in this case, when the UE performs UL synchronization with the SSB-less SCell based on the TA of the specific cell, the TA between the UE and the SSB-less SCell may be derived based on the TA between the UE and the specific cell. For example, an offset may be added/subtracted/multiplied/divided on the basis of the TA between the UE and a specific cell to obtain the TA between the UE and the SSB-less SCell. As another example, the TA between the UE and the SSB-less SCell is the result of a function, and the input of the function includes the TA between the UE and a specific cell.

In some embodiments, when the UE needs to perform UL synchronization with the SSB-less SCell, the UE may determine the TA between the UE and the SSB-less SCell using the TA between the UE and the specific cell, and then perform UL synchronization with the SSB-less SCell based on the TA between the UE and the SSB-less SCell. In some embodiments, the UE may request to activate a specific cell if the specific cell has not yet been activated.

In some embodiments, in order to obtain the TA between the UE and a specific cell, the UE may perform an UL synchronization procedure in the specific cell, such as performing a random access procedure, triggering a random access procedure, or requesting the network to transmit a TAC MAC CE or RAR, or the like. In some embodiments, a new random access trigger condition may be added, for example, to trigger a random access procedure when the UE needs to perform UL synchronization with the SSB-less SCell. Through the random access procedure, the UE may obtain a TA between the UE and a specific cell, and/or a TA between the UE and an SSB-less SCell.

For example, in a case where the UE requests the network to transmit a TAC MAC CE or an RAR, the request message used may be an UL MAC CE, an UL RRC message, or a UCI. That is, the UE may transmit the UL MAC CE, the UL RRC message, or the UCI to the network to request the network to transmit the TAC MAC CE or RAR to the UE. For example, a TA between UE and a specific cell, and/or a TA between UE and an SSB-less SCell may be carried in a TAC MAC CE or RAR,

### Scheme 2B

In Scheme 2B, in a case where UE learns a specific cell of the SSB-less SCell, the UE may perform RA on the specific cell or the SSB-less SCell based on configuration information of a reference signal (such as SSB/TRS/CSI-RS) of the specific cell.

Taking the reference signal as an SSB/TRS/CSI-RS as an example, the UE may acquire a RACH/PRACH configuration for an SSB-less SCell corresponding to the SSB-/TRS/CSI-RS of a specific cell. The RACH/PRACH configuration includes a preamble and/or an RO. The preamble and/or the RO are/is used by the UE when performing RA in the specific cell, and is for the SSB-less SCell (i.e., the RA procedure is performed to obtain the TA between the UE and the SSB-less SCell); or the preamble and/or the RO are/is used by the UE when performing RA on the SSB-less SCell. In some embodiments, the UE may also learn whether UL synchronization (or DL synchronization, or RA) is performed through SSB, TRS, or CSI-RS. In some embodiments, the UE may select a preamble and/or an RO corresponding to a reference signal according to the SSB/TRS/CSI-RS of the specific cell.

The UE may obtain a TA between the UE and the SSB-less SCell and/or a TA between the UE and the specific cell by performing the RA procedure in the specific cell or the SSB-less SCell using a RACH/PRACH resource. For example, in this RA procedure, the network may transmit the TA between the UE and the SSB-less SCell and/or the TA between the UE and a specific cell to the UE in the RAR. The TA between the UE and the specific cell may be used to determine the TA between the UE and the SSB-less SCell. In an example, the TA between the UE and the SSB-less SCell is equal to the TA between the UE and a specific cell; as another example, the TA between the UE and the SSB-less SCell is derived from the TA of a specific cell. After determining the TA between the UE and the SSB-less SCell, the UE may perform UL synchronization with the SSB-less SCell based on the TA.

### Scheme 2C

In Scheme 2C, when UE needs to perform data transmission and/or UL synchronization on the SSB-less SCell, or when the UE is out of UL synchronization from the SSB-less SCell, the UE may request a TA from the network using first request information. The first request information may be, for example, an UL resource or an UL request message.

Here, the UL resource may be a resource on an SSB-less SCell or a resource on a specific cell. The UL resource may be, for example, a PUSCH (such as a PUSCH at a specific time-frequency location). The UL request message may be, for example, any of the following: an SR (or a dedicated SR); a specific UL MAC CE carried on the PUSCH; specific RRC signalling carried on the PUSCH; and UCI (or dedicated UCI).

Exemplarily, the network may determine a TA between the UE and the SSB-less cell and/or a TA between the UE and a specific cell according to the first request information, and further may transmit first indication information to the UE to indicate TA information (including a TA between the UE and the SSB-less cell and/or a TA between the UE and the specific cell) to the UE, and further, the UE may perform UL synchronization with the SSB-less SCell based on the first indication information. The first indication information may be, for example, an RAR, a TAC MAC CE, or another message carrying a TA. In some embodiments, the network may use DL information (e.g., DL boundaries) of a specific cell as a reference for the TA.

It should be understood that the specific cell in schemes 2A to 2C may be, for example, a reference cell, i.e. the above-described specific cell may also be replaced with a reference cell.

Examples of implementations of Schemes 2A to 2C are as follows:

Implementation a: When a network indicates that a SSB-less SCell (denoted as cell #1) and cell #2 (an example of a specific cell) are cells in the same TA group, UE may perform UL synchronization (or timing advance) with Cell #1 based on a TA between the UE and cell #2.

For example, if the UE has a valid TA with cell #2, the UE may perform UL synchronization (or timing advance) with cell #1 using the valid TA with cell #2.

As another example, if the UE does not have a valid TA with cell #2, the UE may send a request message (such as the above-described first request information/second request information/third request information) to the network in cell #2 or cell #1 to request a valid TA from the network. In turn, the network may indicate the valid TA to the UE for the UE to perform UL synchronization (or timing advance) with cell #1.

As another example, if the UE does not have a valid TA with cell #2, the UE may trigger an RA procedure in cell #2 or cell #1, and/or transmit msg1 to the network in cell #2 or cell #1 to obtain a valid TA, and then perform UL synchronization (or timing advance) with cell #1 based on the valid TA.

For example, cell #2 may be a specific cell indicated by the network, or may also be some other specific cell, such as a cell in the same cell group as the SSB-less SCell.

Implementation b: The UE determines a cell (cell #2) that uses/has the same or similar TA as the SSB-less SCell (cell #1). The determination method includes any one of the following: autonomously determined/selected by the UE; pre-configured by the UE; and predefined (as stipulated in the agreement). The UE performs UL synchronization (or timing advance) with cell #1 based on the TA with cell #2.

For example, if the UE has a valid TA with cell #2, the UE performs UL synchronization (or timing advance) with cell #1 using the value of the valid TA with cell #2.

In another example, if the UE does not have a valid TA with the cell #2, the UE may transmit a request message (such as the above-described first request information/second request information/third request information) to the network in the cell #2 or cell #1 to request a valid TA from the network. In turn, the network may indicate the valid TA to the UE for the UE to perform UL synchronization (or TA) with cell #1.

As another example, if the UE does not have a valid TA with cell #2, the UE may trigger an RA procedure in cell #2 or cell #1, and/or transmit msg1 to the network in cell #2 or cell #1 to obtain a valid TA, and then perform UL synchronization (or timing advance) with cell #1 based on the valid TA.

Implementation c: If the UE is out of UL synchronization from the SSB-less SCell (cell #1), or has UL data to be transmitted, or needs to perform UL synchronization, the UE may request a valid TA from the network using a specific resource or resource location. Correspondingly, the network transmits a valid TA to the UE for the UE to perform UL synchronization (or timing advance) with cell #1.

Implementation d: If the UE is out of UL synchronization from the SSB-less SCell (cell #1), or has UL data to be transmitted, or needs to perform UL synchronization, the UE may trigger an RA procedure on cell #2 or cell #1. As an example, the UE may select a reference signal to be used based on a reference signal configuration of cell #2 (e.g., SSB/TRS/CSI-RS) and/or channel quality information of the reference signal, and perform an RA procedure using a resource on cell #1 (e.g., preamble and/or RO). As an implementation, the UE may transmit msg3/MSGA in cell #1 and receive msg2 or 4 in cell #2.

Implementation e: If the UE is out of UL synchronization from the SSB-less SCell (cell #1), or has UL data to be transmitted, or needs to perform UL synchronization, the UE triggers an RA procedure on cell #2 or cell #1.

For example, the UE may obtain a TA between the UE and the cell #2 through the RA procedure, and the TA between the UE and the cell #2 may be used to determine the TA between the UE and the cell #1 (the TA between the UE and the cell #1 is equal to the TA between the UE and the cell #2, or the TA between the UE and the cell #1 is derived based on the TA between the UE and the cell #2).

As another example, the UE may acquire (e.g., directly acquire) the TA between the UE and cell #1 through the RA procedure.

In another example, the UE may simultaneously acquire the TA between the UE and the cell #2 and the TA between the UE and the cell #1 through the RA procedure.

In some embodiments, in the RA procedure, the UE may indicate to the network that it is necessary to acquire a TA between the UE and cell #2 or UL synchronize with the cell #2. As an implementation, the UE may indicate this information through msg1/msgA/msg3. For example, information in a specific preamble, RO, PUSCH, such as a Radio Network Temporary Identifier (RNTI), an MAC CE, etc. is carried or indicated to the network.

The UL synchronization scheme for the aforementioned scenario 2a has been described above, and in some embodiments, in the aforementioned scenario 1, when the UE performs UL synchronization on the SSB-less SCell, the UE may perform an RA procedure (such as replacing the related operation for the SSB with the related operation for the TRS) based on the TRS/CSI-RS of the SSB-less SCell. Alternatively, when the UE performs UL synchronization on the SSB-less SCell, the RA procedure may be performed based on a reference signal of a specific cell (e.g., a reference cell) of the SSB-less SCell (similar to the manner for scenario 2a in schemes 2a to 2C).

In some embodiments, for the aforementioned scenario 2, for the SSB-less SCell, the UE may perform timing based on the DL or UL data signal of the SSB-less SCell. For example, the UE may perform DL timing or DL synchronization based on the DL data signal of the SSB-less SCell. For another example, the UE may perform UL timing or acquire TA based on the UL data signal of the SSB-less SCell.

According to the above technical solution, it is described how UE in the connected state or the unconnected state communicates with the SSB-less SCell (e.g., UL synchronization).

Another method of communication provided by an embodiment of the present disclosure will be described below with reference to FIG. 3.

FIG. 3 illustrates another method of communication provided by an embodiment of the present disclosure, and the method may include:

S301, a terminal device receives a reference signal of a second cell or a DL data signal of a first cell, the reference signal or the DL data signal is used for the terminal device to perform DL synchronization or DL timing with the first cell, the second cell is a cell for the terminal device to perform DL synchronization or DL timing with the first cell, and the first cell is a secondary cell with no SSB transmission.

In a possible manner, the terminal device may receive a DL data signal of the first cell (e.g., receiving a DL data signal of the first cell from the network device), so that the terminal device may perform DL synchronization or DL timing with the first cell based on the DL data signal.

In another possible manner, the terminal device may receive a reference signal of the second cell (e.g., receiving a reference signal of the second cell from the network device), so that the terminal device may perform DL synchronization or DL timing with the first cell based on the reference signal.

Exemplarily, the type of the reference signal may be, for example, any one of SSB, TRS, CSI-RS. That is, the terminal device may perform DL synchronization or DL timing with the first cell using any reference signal among the SSB, the TRS, and the CSI-RS.

Exemplarily, at least part of the configuration information of the reference signal (i.e., a reference signal for the terminal device to perform DL synchronization or DL timing with the first cell) may be indicated by the network device; and/or at least part of the configuration information of the reference signal may be read by the terminal device from the second cell.

In an example, the network device may transmit (indicate) at least part of the configuration information of the reference signal to the terminal device, and correspondingly, the terminal device may receive the at least part of the configuration information from the network device. In this case, the terminal device may not need to read the at least part of the configuration information from the second cell. In another example, the terminal device may read at least part of the configuration information of the reference signal from the second cell. In yet another example, the network device may transmit (indicate) at least part of configuration information of the reference signal to the terminal device, and the terminal device may read the remaining at least part of configuration information of the reference signal from the second cell.

As an example, when the type of the reference signal is SSB, at least part of the configuration information of the SSB may be, for example, at least part of information in MIB and/or SIB1 (for example: ssb-SubcarrierOffset and/or systemFrameNumber); when the reference signal is CSI-RS or TRS, at least part of the configuration information of the CSI-RS or TRS may be, for example, at least part of the information of the CSI-RS or TRS (for example, at least one of scellActivationRS-Id, SCellActivationRS-ConfigId-r17, resourceSet, NZP-CSI-RS-ResourceSetId, gapBetweenBursts, and qcl-Info-r17).

In some embodiments, in a case where the reference signal of the second cell is used for the terminal device to perform DL synchronization or DL timing with the first cell, the type of the reference signal is indicated by the network device. That is, the type of the reference signal used by the terminal device is indicated by the network device in the process of performing DL synchronization or DL timing with the first cell. In other words, the network device may indicate to the terminal device which reference signal is used to perform DL synchronization or DL timing with the first cell. For example, the network device may indicate to the terminal device whether the SSB, TRS, or CSI-RS is used to perform DL synchronization or DL timing with the first cell.

Hereinafter, the second cell in this embodiment will be described.

In some embodiments, the second cell may be indicated by the network device, or the second cell may be preconfigured by the terminal device or the network device, or the second cell may be predefined (as predefined by the protocol), or the second cell may be determined/selected by the terminal device. In other words, which cell is the cell for the terminal device to perform DL synchronization or DL timing with the first cell is indicated by the network device, or is preconfigured by the terminal device or the network device, or is predefined (as predefined by the protocol), or is determined/selected by the terminal device.

In some embodiments, the second cell may be determined/selected by the terminal device based on first information from the network device, and the first information may include, for example, at least one of: location information of the network device; location information of a neighboring network device of the network device; location information of a third cell included in the network device, wherein the third cell is a cell where the terminal device is located; location information of a cell adjacent to the third cell; co-located information between network devices; co-located information between cells; QCL information between reference signals; QCL information between channels; and positioning information.

In some embodiments, the second cell may be indicated by the network device through third indication information. For example, the network device may transmit the third indication information to the terminal device, and correspondingly, the terminal device may receive the third indication information from the network device, so that the terminal device may learn based on the third indication information that the second cell is a cell for the terminal device to perform DL synchronization or DL timing with the first cell.

Exemplarily, the third indication information may include, for example, a frequency point and/or a cell identity of the second cell. The frequency point may be a frequency point index, such as an index among adjacent frequency points in SIB3/4/5, or a frequency point index (a frequency point index of a serving cell) of SIB2. Alternatively, the frequency point may be a frequency point value (ARFCN-ValueNR). Alternatively, the frequency point may be a frequency point value of SIB2 (the frequency point value of the serving cell). The cell identity may be, for example, a Physical Cell Identity (PCI) or a global cell identity. In some embodiments, a frequency point value may be provided using absoluteFrequencySSB, or other IEs. In some embodiments, when the frequency point value may be provided using absoluteFrequencySSB, the frequency point may be a frequency point of a current serving cell, or the frequency point of a reference cell or a downlink timing acquisition cell (for example, when the SSB-less SCell obtains the downlink timing from another cell, the frequency point of said another or that of the SSB of said another cell is given).

In some embodiments, the third indication information may be configured under a first condition. The first condition may include, for example, at least one of the following: a condition of SCellAdd; a condition of SCellAddMod; a condition of SCellOnly; and a condition of SCelladdOnly. That is, the third indication information may be configured under at least one of the condition of SCellAdd, the condition of SCellAddMod, the condition of SCellOnly, and the condition of SCelladdOnly. As an embodiment, the third indication information may be configured under the condition of SCellAdd, or may be configured under the condition of SCellAddMod, or may be configured under the condition of SCellOnly, or may be configured under the condition of SCelladdOnly. A description of the above conditions can be found in Table 1 below.

In some embodiments, the third indication information is optionally configurable in the case of SCell addition.

In some embodiments, if the third indication information is present, or if the network device transmits the third indication information to the terminal device, the terminal device may perform DL synchronization or DL timing with the first cell based on the second cell indicated by the third indication information. If the third indication information is absent, or if the network device does not transmit the third indication information to the terminal device, the terminal device may use a default cell as the second cell, and perform DL synchronization or DL timing with the first cell based on the default cell, or the terminal device may autonomously determine/select a cell as the second cell, and perform DL synchronization or DL timing with the first cell based on the determined/selected cell.

In some embodiments, the first cell and the second cell belong to the same TA group and/or cell group.

In a possible manner, the TA group and/or cell group may be determined by the network device based on second information. Exemplarily, the second information may include, for example, at least one of: a measurement result of the reference signal; positioning information (e.g., location information of a terminal device and/or location information of a network device adjacent to the terminal device); motion trajectory information of the terminal device; location information of the network device; location information of a neighboring network device of the network device; location information of a third cell included in the network device, wherein the third cell is a cell where the terminal device is located; location information of a cell adjacent to the third cell; co-located information between network devices; and co-located information between cells.

Here, at least one of the measurement result of the reference signal, the positioning information, and the motion trajectory information of the terminal device may be, for example, transmitted by the terminal device to the network device. That is, the terminal device may transmit at least one piece of information among the measurement result of the reference signal, the positioning information, and the motion trajectory information of the terminal device to the network device for determining the TA group and/or the cell group by the network device.

In some embodiments, the second cell may be activated by the terminal device as instructed by the network device, or the second cell may be activated by the terminal device under a second condition.

In a possible case, the second cell is activated by the terminal device as instructed by the network device. In an example, the network device may instruct the terminal device to activate the second cell through a RRC configuration. For example, the network device may set scellState in the RRC configuration (as in SCellConfig) to activated to indicate activation of the second cell. As another example, the network device may use a MAC CE (such as an Scell Activation/Deactivation MAC CE, an enhanced Sell Activation/Deactivation MAC CE, Or a new SCell activation/deactivation MAC CE) to instruct the terminal device to activate the second cell.

Another possible scenario is that the second cell is activated by the terminal device under the second condition.

Exemplarily, the second condition may include, for example, at least one of the following: a deactivation timer of the second cell timing out; the deactivation timer of the second cell needing to be started; the deactivation timer of the second cell needing to be restarted; the terminal device obtaining indication information for indicating the second cell; the terminal device obtaining a reference signal of the second cell; the terminal device performing uplink synchronization or downlink synchronization with the first cell; the terminal device obtaining a configuration of the first cell; the first cell being activated; and, the first cell needing to be activated.

According to the method of this embodiment, it is described how a terminal device performs DL synchronization or DL timing with the first cell (SSB-less Scell).

In order to facilitate understanding of the embodiments of the present disclosure, a possible implementation scheme applicable for the method shown in FIG. 3 will be described below in conjunction with examples, for example, for the aforementioned scenario 2a.

In some embodiments, a specific cell needs to be activated in order to achieve DL synchronization or DL timing between the UE and the SSB-less SCell. The specific cell is a cell for UE to perform DL synchronization or DL timing with the first cell. In this embodiment, the specific cell may be, for example, a reference cell, or the specific cell may be replaced with a reference cell.

As an example, for a specific cell, a network may set scellState (as in SCellConfig) to activated so as to activate the specific cell, or the network may use an MAC CE (such as an Scell Activation/Deactivation MAC CE, an enhanced Sell Activation/Deactivation MAC CE, or a new SCell activation/deactivation MAC CE) to activate the specific cell, or the UE may start or restart the sCellDeactivationTimer in a case where the specific cell is acquired as a certain SCell or in a case where synchronization with the SSB-less SCell is performed based on the specific cell, or the UE may activate the specific cell under the second condition. The second condition may include, for example, at least one of: obtaining indication information for indicating a specific cell; obtaining a reference signal of the specific cell (such as SSB/CSI-RS/TRS); the UE performing uplink synchronization or downlink synchronization with the SSB-less SCell; obtaining the configuration of the SSB-less SCell; the SSB-less SCell being activated or needing to be activated.

It should be understood that the above-described scheme of activating a specific cell may also be applied to other embodiments in the present disclosure.

In some embodiments, for an SSB-less SCell, the network may indicate to the UE which cell (e.g., indicating a cell identity, an SSB frequency point, etc.) is a specific cell of the SSB-less SCell. Correspondingly, the UE may perform DL synchronization or DL timing with the SSB-less SCell based on the SSB of the specific cell. In some embodiments, the network may simultaneously indicate SSB configuration information of the specific cell to the UE, such as at least part of information in an MIB and/or SIB1 (e.g., ssb-SubcarrierOffset and/or systemFrameNumber). It can be understood that if the network indicates the SSB configuration information of the specific cell, the UE may not need to read the SSB configuration information (such as MIB and/or SIB1) of the specific cell from the specific cell.

In some embodiments, for an SSB-less SCell, the network may indicate to the UE which cell (e.g., indicating a cell identity, an SSB frequency point, etc.) is a specific cell of the SSB-less SCell. Correspondingly, the UE may perform DL synchronization or DL timing with the SSB-less SCell according to the CSI-RS or TRS of the specific cell. In some embodiments, the network may simultaneously indicate configuration information of at least part of the CSI-RS or TRS of the specific cell to the UE, such as at least part of information of the CSI-RS or TRS (e.g., at least one of scellActivationRS-Id, SCellActivationRS-ConfigId-r17, resourceSet, NZP-CSI-RS-ResourceSetId, gapBetweenBursts, qcl-Info-r17). It can be understood that when the network indicates the configuration information of the CSI-RS or TRS of the specific cell, the UE may not need to access the specific cell to obtain the configuration information of the CSI-RS or TRS.

In some embodiments, for an SSB-less SCell, if the network does not indicate to the UE which cell (e.g., cell identity, SSB frequency point, etc.) is a specific cell of the SSB-less SCell, the UE may perform DL synchronization or DL timing with the SSB-less SCell based on a reference signal (e.g., SSB/CSI-RS/TRS) of a default cell, that is, the UE may use the default cell as the specific cell of the SSB-less SCell. Exemplarily, the UE may learn which cell is the default cell, e.g. by any of the following: network indication; autonomous determination/selection of the UE; predefinition (e.g. predefined by protocol); pre-configuration of the UE. As an example, the default cell may be, for example, any of the following cells: a PCell; a PSCell; a PCell or PSCell in the same cell group as the SSB-less SCell; any cell in the same cell group as the SSB-less SCell; a cell with the smallest cell index in the same cell group as the SSB-less SCell; a cell with the largest cell index in the same cell group as the SSB-less SCell; any cell in the same TA group as the SSB-less SCell; a cell with the smallest cell index in the same TA group as the SSB-less SCell; a cell with the largest cell index in the same TA group as the SSB-less SCell.

In some embodiments, the network may indicate configuration information of a reference signal (e.g., SSB/CSI-RS/TRS) of a default cell to the UE. For example, for an SSB, the network may indicate at least part of information in an MIB and/or SIB1 (e.g., ssb-SubcarrierOffset and/or systemFrameNumber). In this case, the UE may not need to read the SSB configuration information (such as MIB and/or SIB1) of the default cell from the default cell. For example, for the CSI-RS or TRS, the network may indicate at least part of information of the CSI-RS or TRS (e.g., at least one of scellActivationRS-Id, SCellActivationRS-ConfigId-r17, resourceSet, NZP-CSI-RS-ResourceSetId, gapBetweenBursts, qcl-Info-r17). In this case, the UE may not need to access the default cell to acquire configuration information of the CSI-RS or TRS.

In some embodiments, the UE may perform DL synchronization or DL timing with the SSB-less SCell according to the SSB/CSI-RS/TRS of the specific cell/default cell. For example, the UE may receive or measure the SSB/CSI-RS/TRS of a specific cell/default cell to obtain synchronization information, and may consider that the synchronization information is also synchronization information of the SSB-less SCell, and further, the UE may perform DL synchronization or DL timing with the SSB-less SCell based on the synchronization information.

In some embodiments, for a specific cell/default cell, the network may indicate to the UE which reference signal of the specific cell/default cell is used as a basis for performing DL synchronization or DL timing with the SSB-less SCell. For example, the network may instruct the UE to perform DL synchronization or DL timing according to SSB, CSI-RS or TRS.

An example of an implementation manner of the DL synchronization or DL timing scheme is as follows:

As an example, if the network configures a configuration of the SSB-less SCell (denoted as Cell #1) for UE, and/or indicates that the SCell (denoted as Cell #2) is a specific cell of Cell #1, the network may use an MAC CE or RRC configuration (e.g., scellState) to instruct the UE to activate Cell #2. Correspondingly, the UE may activate cell #2 and perform DL synchronization or DL timing with cell #1 according to the SSB configuration of cell #2 (for example, the network instructs the UE to perform DL synchronization or DL timing based on the SSB of cell #2).

The DL synchronization/DL timing scheme for the aforementioned scenario 2a has been described above, and in some embodiments, for the aforementioned scenario 2, the UE may perform timing based on the DL or UL data signal of the SSB-less SCell. For example, the UE may perform DL timing or DL synchronization based on the DL data signal of the SSB-less SCell. For another example, the UE may perform UL timing or acquire a TA based on the UL data signal of the SSB-less SCell.

In some embodiments, the network may indicate a specific cell and/or a default cell to the UE through a first parameter (corresponding to the third indication information in the preceding embodiment). That is, the first parameter may be used to indicate which cell the specific cell and/or the default cell is. As an example, the first parameter may include, for example, information of the specific cell and/or the default cell (e.g., frequency point, cell identity, etc.). That is, the network may indicate the specific cell and/or the default cell to the UE by indicating information (such as frequency point, cell identity, etc.) of the specific cell and/or the default cell. The frequency point may be a frequency point index, such as an index among adjacent frequency points in SIB3/4/5, or a frequency point index (a frequency point index of a serving cell) of SIB2. Alternatively, the frequency point may be a frequency point value (ARFCN−ValueNR). Alternatively, the frequency point may be a frequency point value of SIB2 (the frequency point value of the serving cell). The cell identity may be, for example, a PCI, or a global cell identity. In some embodiments, the frequency point value may be provided using absoluteFrequencySSB, or other IEs. In some embodiments, when the frequency point value may be provided using absoluteFrequencySSB, the frequency point may be the frequency point of a current serving cell, or the frequency point of the reference cell or a downlink timing acquisition cell (for example, when the SSB-less SCell obtains the downlink timing from another cell, the frequency point of said another cell or the SSB of said another cell is given).

Exemplarily, the first parameter may be configured, for example, under a first condition. The first condition may include, for example, at least one of: a condition of SCellAdd; a condition of SCellAddMod; a condition of SCellOnly; and a condition of SCelladdOnly. That is, the first parameter may be configured under at least one of the condition of SCellAdd, the condition of SCellAddMod, the condition of SCellOnly, and the condition of SCelladdOnly. As an implementation, the first parameter may be configured under the condition of SCellAdd, or under the condition of SCellAddMod, or under the condition of SCellOnly, or under the condition of SCelladdOnly. A description of the above conditions can be found in Table 1.

TABLE 1

| | |
|---|---|
| SCellAdd | The field is mandatory present upon SCell |
| | addition; otherwise it is absent, Need M. |
| SCellAddMod | The field is mandatory present upon SCell |
| | addition; otherwise it is optionally present, |
| | need M. |
| SCellOnly | The field is optionally present, Need R, in |
| | ServingCellConfigCommon of an SCell. It is |
| | absent otherwise. |
| SCellAddOnly | It is optionally present, Need S, for (non- |
| | PUCCH) SCells when adding a new SCell. |
| | The field is absent, Need M, when |
| | reconfiguring SCells. The field is also absent |
| | for the SpCells as well as for a PUCCH |
| | SCell. |

Exemplarily, the first parameter may for example be included in at least one of the following information: Reconfiguration, Reconfiguration WithSync; ScellConfig; ServingCellConfigCommon; downlinkConfigCommon; and Frequency InfoDL.

In a possible manner, the first parameter is used to indicate a specific cell. In this case, if the first parameter is present, or if the network indicates the first parameter to the UE, the UE may obtain a timing reference based on the specific cell indicated by the first parameter; if the first parameter is absent, or if the network does not indicate the first parameter to the UE, the UE may obtain a timing reference based on a default cell or a cell determined autonomously by the UE.

In another possible manner, the first parameter is used to indicate a default cell. In this case, if the first parameter is present, or if the network indicates the first parameter to the UE, the UE may obtain a timing reference based on the default cell indicated by the first parameter; if the first parameter is absent, or if the network does not indicate the first parameter to the UE, the UE may obtain a timing reference based on the cell determined autonomously by the UE.

In some embodiments, the use of the first parameter by the UE described above may be only supported in case the SCell for which the UE obtains the timing reference is in the different frequency band as the cell from which the UE obtains the timing reference, and/or only supported in case the SCell for which the UE obtains the timing reference is in the inter-band and co-located as the cell from which the UE obtains the timing reference.

In some embodiments, when configuring the SSB-less SCell to UE and in the case that UE needs to obtain the timing reference for this SCell from another cell on the different frequency band, the network would add the new indication in FrequencyInfoDL IE to indicate which is the specific cell (or reference cell) of this SCell. In some embodiments, the information of the specific cell (or reference cell) would at least include SSB frequency and PCI. The SSB frequency would be represented as ARFCN-ValueNR and the PCI would be represented as PhysCellId. In some embodiments, the information of the specific cell (or reference cell) may include only the SSB frequency or may include only the SSB frequency and the PCI. In some embodiments, the SSB frequency or frequency point value may be provided using absoluteFrequencySSB, or other IEs. In some embodiments, when the frequency point value may be provided using absoluteFrequencySSB, the frequency point may be the frequency point of the current serving cell, or the frequency point of the reference cell or the downlink timing acquisition cell (for example, when the SSB-less SCell acquires the downlink timing from another cell, the frequency point of said another cell or that of the SSB of said another cell is given). In some embodiments, when absoluteFrequencySSB is present, or when absoluteFrequencySSB is present and PCI is configured, the UE obtains the timing reference of the SSB-less SCell from another cell, such as the specific cell or the reference cell. In some embodiments, information of the specific cell (or reference cell) would be optionally present upon adding a new SCell.

In some embodiments, in the case that absoluteFrequencySSB is absent and/or the UE obtains the timing reference for SSB-less SCell from the specific cell (reference cell) that is on the different frequency band, FrequencyInfoDL IE is extended to indicate the information of the specific cell (reference cell). In some embodiments, the information of the specific cell (reference cell) includes ARFCN−ValueNR and PhysCellId of the specific cell (reference cell). In some embodiments, the information of the specific cell (or reference cell) may include only the SSB frequency or may include only the SSB frequency and the PCI. In some embodiments, the SSB frequency or frequency point value may be provided using absoluteFrequencySSB, or other IEs. In some embodiments, when the frequency point value may be provided using absoluteFrequencySSB, the frequency point may be the frequency point of the current serving cell, or the frequency point of the reference cell or the downlink timing acquisition cell (for example, when the SSB-less SCell acquires the downlink timing from another cell, the frequency point of said another cell or that of the SSB of said another cell is given). In some embodiments, when absoluteFrequencySSB is present, or when absoluteFrequencySSB is present and PCI is configured, the UE obtains the timing reference of the SSB-less SCell from another cell, such as the specific cell or the reference cell.

In some embodiments, in the case where the absoluteFrequencySSB is absent and/or UE is configured with a specific cell (or reference cell), or in the case where the absoluteFrequencySSB is absent and/or the UE is configured with a specific cell (or reference cell) to obtain the timing reference of the SSB-less Scell, the UE obtains the timing reference through the specific cell (or reference cell), or obtains the timing reference of the SSB-less Scell. In some embodiments, information for the specific cell (or reference cell) is included in the FrequencyInfoDL IE. In some embodiments, the information of the specific cell (or reference cell) includes ARFCN ValueNR and/or PhysCellId of the specific cell (or reference cell).

In some embodiments, if absoluteFrequencySSB is absent and/or the information of the specific cell (or reference cell) is present, the UE obtains the timing reference for SSB-less SCell from the specific cell (or reference cell). In some embodiments, this scheme may be only supported in case the SCell for which the UE obtains the timing reference is in the different frequency band as the cell (i.e., the specific cell) from which the UE obtains the timing reference. In some embodiments, the information of the specific cell (or reference cell) may include only the SSB frequency, or may include only the SSB frequency and PCI. In some embodiments, the SSB frequency or frequency point value may be provided using absoluteFrequencySSB, or other IEs. In some embodiments, when the frequency point value may be provided using absoluteFrequencySSB, the frequency point may be the frequency point of the current serving cell, or the frequency point of the reference cell or the downlink timing acquisition cell (for example, when the SSB-less SCell obtains the downlink timing from another cell, the frequency point of said another cell or that of the SSB of said another cell is given). In some embodiments, when absoluteFrequencySSB is present, or when absoluteFrequencySSB is present and PCI is configured, the UE obtains the timing reference of the SSB-less scell from another cell, such as the specific cell or the reference cell.

In some embodiments, if absoluteFrequencySSB is absent and/or the information for the specific cell (or reference cell) is absent, the UE follows the legacy behaviour, i.e. the UE obtains timing reference from the SpCell or the SCell, if applicable. In some embodiments, this scheme may be only supported in case the SCell for which the UE obtains the timing reference is in the same frequency band as the cell (i.e., SpCell or SCell, respectively) from which the UE obtains the timing reference. In some embodiments, the information of the specific cell (or reference cell) may include only the SSB frequency, or may include the SSB frequency and PCI. In some embodiments, the SSB frequency or frequency point value may be provided using absoluteFrequencySSB, or other IEs. In some embodiments, when the frequency point value may be provided using absoluteFrequencySSB, the frequency point may be the frequency point of the current serving cell, or the frequency point of the reference cell or the downlink timing acquisition cell (for example, when the SSB-less SCell obtains the downlink timing from another cell, the frequency point of said another cell or that of the SSB of said another cell is given). In some embodiments, when absoluteFrequencySSB is present, or when absoluteFrequencySSB is present and PCI is configured, the UE obtains the timing reference of the SSB-less SCell from another cell, such as a specific cell or a reference cell.

In some embodiments, if absoluteFrequencySSB is absent and/or the information of the specific cell (or reference cell) is absent, the UE obtains the timing reference for SSB-less SCell from the intra-band cell or Pcell or default cell. In some embodiments, whether the obtaining is from the intra-band cell or Pcell or default cell depends on the UE implementation or the network indication.

In some embodiments, if absoluteFrequencySSB is absent and/or the information of the specific cell (or reference cell) is not configured, the UE obtains the timing reference for SSB-less SCell from the in-band cell or Pcell or other Scell or default cell. In some embodiments, which cell the UE obtains the timing reference from is determined by the UE implementation, or is predefined, or is preconfigured by the network, or is additionally indicated by the network.

According to the above technical solution, it is described how UE performs DL synchronization or DL timing with the SSB-less SCell.

It should be understood that the above-described scheme regarding the third indication information (first parameter), for example, may be applicable to scenarios about how UE determines DL timing, or how the UE determines timing reference, or to scenarios about how a specific cell or a timing reference cell is indicated or determined.

It should also be understood that the above-described scheme with respect to the third indication information (first parameter) can be applied, for example, to the aforementioned scenario 1, scenario 2, and scenario 2a.

It should also be understood that the above scenarios regarding how the UE determines the DL timing, or how the UE determines the timing reference, or a scenario applicable to how to indicate or determine a specific cell or a timing reference cell may be applicable to the aforementioned scenario 1, scenario 2, and scenario 2a.

It should also be understood that the above-described scheme regarding the third indication information (first parameter) may be implemented in combination with the method shown in FIG. 2 or FIG. 3, or may be implemented alone, and the embodiments of the present disclosure are not limited thereto. That is, an embodiment of the present disclosure also provides a method of communication, in which the third indication information (first parameter) may be used to indicate a second cell (such as a specific cell and/or a default cell). The description of the third indication information (first parameter) may refer to the foregoing embodiments, and will not be repeated here.

FIG. 4 illustrates another method of communication provided by an embodiment of the present disclosure, and the method may include:

S401: A terminal device receives a first MAC CE from a network device, and the first MAC CE is used to indicate a reporting manner of a first CSI report having a sub-reporting configuration.

The reporting manner may also be referred to as an activation mode.

In this embodiment, the network device may transmit the first MAC CE to the terminal device, and correspondingly, the terminal device may receive the first MAC CE from the network device. The first MAC CE is configured to indicate at least a reporting manner of a first CSI report having a sub-reporting configuration.

As an implementation, for example, the first MAC CE may include indications or locations of a plurality of sub-reporting configurations corresponding to the first CSI report, and indicate the terminal device to report the first CSI report when the indication or location of any of the sub-reporting configurations is set to activated. For example, assuming that the first MAC CE includes indications or locations of four sub-reporting configurations corresponding to the first CSI report, if the indication or location of any of the four sub-reporting configurations (for example, the indication or location of any sub-reporting configuration among the indications or locations of the first to fourth sub-reporting configurations) is set to activated, it means that the terminal device needs to report the first CSI report.

In a possible manner, when a value of an indication or location (e.g., bitmap location) of a sub-reporting configuration is set to a first specific value (e.g., 1), it indicates that the indication or location of the sub-reporting configuration is set to activated; when a value of an indication or location of a sub-reporting configuration is set to a second specific value (such as 0), it indicates that the indication or location of the sub-reporting configuration is set to deactivated.

For example, in a case where the first MAC CE indicates the terminal device to report the first CSI report, among the indications or locations of the plurality of sub-reporting configurations corresponding to the first CSI report, the number of indications or locations of the sub-reporting configurations set to activated is greater than or equal to 1. For example, assuming that the first MAC CE includes indications or locations of four sub-reporting configurations corresponding to the first CSI report, if the MAC CE indicates that the terminal device needs to report the first CSI report, the indication or location of at least one of the four sub-reporting configurations may be set to activated, for example, the indications or locations of the first and fourth sub-reporting configurations may be set to activated.

In some embodiments, if the number of indications or locations of sub-reporting configurations set to activated is greater than 1 among the indications or locations of a plurality of sub-reporting configurations corresponding to the first CSI report, it is known that the first CSI report is a CSI report with a sub-reporting configuration.

In some embodiments, for each of the plurality of sub-reporting configurations corresponding to the first CSI report, when the indication or location of the sub-reporting configuration is set to activated, the first MAC CE is further configured to indicate the terminal device to report a sub-report corresponding to the sub-reporting configuration in the first CSI report. For example, assuming that the first MAC CE includes indications or locations of four sub-reporting configurations corresponding to the first CSI report, if the indication or location of the first sub-reporting configuration and the indication or location of the third sub-reporting configuration are set to activated, the first MAC CE may further indicate the terminal device to report the sub-reports corresponding to the first sub-reporting configuration and the third sub-reporting configuration in the first CSI report in addition to indicating the terminal device to report the first CSI report.

In some embodiments, the first MAC CE is further used to indicate a reporting manner of a second CSI report having no sub-reporting configuration. That is, the first MAC CE may be used to indicate the reporting manner of the first CSI report with a sub-reporting configuration and the reporting manner of the second CSI report with no sub-reporting configuration.

As an implementation, the first MAC CE may include, for example, indications or locations of a plurality of sub-reporting configurations corresponding to the second CSI report, and indicates the terminal device to report the second CSI report when any of the indications or locations of the plurality of sub-reporting configurations is set to activated. For example, assuming that the first MAC CE includes indications or locations of four sub-reporting configurations corresponding to the second CSI report, if the indication or location of any of the four sub-reporting configurations (for example, the indication or location of any sub-reporting configuration among the first to fourth sub-reporting configurations) is set to activated, it means that the terminal device needs to report the second CSI report.

For example, in a case where the first MAC CE indicates the terminal device to report the second CSI report, among the indications or locations of the plurality of sub-reporting configurations corresponding to the second CSI report, the number of indications or locations of the sub-reporting configurations set to activated is 1. For example, assuming that the first MAC CE includes indications or locations of four sub-reporting configurations corresponding to the second CSI report, if the first MAC CE indicates the terminal device to report the second CSI report, the indication or location of one sub-reporting configuration among the four sub-reporting configurations is set to activated, for example, the indication or location of the first sub-reporting configuration is set to activated, in which case the indications or locations of the other three sub-reporting configurations may not need to be configured.

In a possible aspect, in a case where the first MAC CE is used to indicate both the reporting manner of the first CSI report with a sub-reporting configuration and the reporting manner of the second CSI report with no sub-reporting configuration, the length of the first MAC CE is fixed, so that the terminal device does not need to determine the length of the first MAC CE to facilitate implementation.

In some embodiments, the first MAC CE is not used to indicate the reporting manner of the second CSI report with no sub-reporting configuration. That is, the first MAC CE may be used to indicate the reporting manner of the first CSI report with a sub-reporting configuration, but not to indicate the reporting manner of the second CSI report with no sub-reporting configuration.

In some embodiments, the second CSI report may be indicated by a second MAC CE in a case where the first MAC CE is not used to indicate the reporting manner of the second CSI report with no sub-reporting configuration. The second MAC CE may be, for example, an existing MAC CE, such as: SP CSI reporting on PUCCH Activation/Deactivation MAC CE. The second MAC CE is configured to indicate at least a reporting manner of a second CSI report with no sub-reporting configuration.

In a possible manner, the length of the first MAC CE is fixed or variable in a case where the first MAC CE is used to indicate the reporting manner of the first CSI report with a sub-reporting configuration and is not used to indicate the reporting manner of the second CSI report with no sub-reporting configuration. In a case where the length of the first MAC CE is fixed, the terminal device may not need to determine the length of the first MAC CE, which is convenient to implement. In a case where the length of the first MAC CE is variable, flexible adjustment of the length of the first MAC CE can be realized.

In some embodiments, the MAC CE may be identified using a new Logical Channel ID (LCID), such as an E-LCID.

In some embodiments, in a case where the network device transmits the first MAC CE to the terminal device, the terminal device does not use the legacy MAC CE. Here, the legacy MAC CE is used to indicate a reporting manner of a CSI report having a reporting configuration, but is not used to indicate a reporting manner of a CSI report having no sub-reporting configuration.

In some embodiments, in a case where the network device transmits the first MAC CE to the terminal device, the terminal device may still use the legacy MAC CE. In this case, if the indication or location of a certain reporting configuration included in the conventional MAC CE is set to activated, it is considered that the indications or locations of all sub reporting configurations corresponding to the reporting configuration are set to activated.

According to the method of this embodiment, it is described how a network device indicates a reporting manner of a CSI report to a terminal device through an MAC CE. In this embodiment, the CSI report (e.g., the first CSI report; as another example, the second CSI report) may be, for example, a Semi-Persistent (SP) CSI report.

In order to facilitate understanding of the embodiments of the present disclosure, possible implementation schemes (including scheme 4A and scheme 4B) applicable for the method shown in FIG. 4 will be described below with reference to examples.

### Scheme 4A

An MAC CE includes: indication information for a CSI report (corresponding to the first CSI report in the foregoing embodiments) with a sub-configuration (sub-config) (i.e., the sub-reporting configuration), and indication information for a CSI report (corresponding to the second CSI report in the foregoing embodiments) with no sub-configuration. The indication information for a CSI report with a sub-configuration is used to indicate to UE whether the CSI report with the sub-configuration needs to be reported. The indication information for a CSI report with no sub-configuration is used to indicate to the UE whether the CSI report with no sub-configuration needs to be reported. That is, the MAC CE may be used to indicate to the UE whether or not a CSI report with a sub-configuration needs to be reported, and may be used to indicate to the UE whether or not a CSI report with no sub-configuration needs to be reported.

As an implementation, the MAC CE may not need to explicitly differentiate whether or not a CSI report has a sub-configuration. In this case, if a CSI report has a sub-configuration, the number of locations with a specific value (such as 1) in a bitmap corresponding to the sub-configuration may be more than one; if a CSI report does not have the sub-configuration, the number of locations with a specific value (such as 1) in the bitmap corresponding to the sub-configuration may be inferred as 0 or 1. 0 indicates that the CSI report does not need to be reported, and 1 indicates that the CSI report needs to be reported.

In Scheme 4A, the length of the MAC CE may be, for example, a fixed length.

In some embodiments, the MAC CE may be identified using a new LCID, such as an E-LCID.

### Scheme 4B

An MAC CE includes indication information for a CSI report having a sub-configuration (corresponding to the first CSI report in the foregoing embodiments), and does not include indication information for a CSI report having no sub-configuration (corresponding to the second CSI report in the foregoing embodiments). The indication information for a CSI report with a sub-configuration is used to indicate to UE whether the CSI report with a sub-configuration needs to be reported. That is, the MAC CE may be used to indicate to the UE whether or not a CSI report with a sub-configuration needs to be reported, but may not be used to indicate to the UE whether or not a CSI report with no sub-configuration needs to be reported.

As an implementation mode, if a CSI report has a sub-configuration, there may be more than one location with a specific value (such as 1) in a bitmap corresponding to the sub-configuration.

In Scheme 4B, the length of the MAC CE may be, for example, a fixed length, or may be a variable length.

In some embodiments, the MAC CE may be identified using a new LCID, such as an E-LCID.

In some embodiments, since the MAC CE does not include indication information for a CSI report with no sub-configuration, another MAC CE (corresponding to the second MAC CE in the foregoing embodiments) may be used to carry at least indication information for a CSI report with a sub-configuration. The another MAC CE may be, for example, an existing MAC CE, such as: SP CSI reporting on PUCCH Activation/Deactivation MAC CE.

Examples of implementations of Scheme 4A and Scheme 4B are as follows:

Referring to Tables 2 and 3, examples of reporting manners in which a network indicates a CSI report to UE through an MAC CE are shown. Here, Table 2 is applicable, for example, to Scheme 4A and Scheme 4B; Table 3 is applicable to Scheme 4B, for example.

TABLE 2

| R | Serving Cell ID | | | | | BWP ID | | oct1 |
|---|---|---|---|---|---|---|---|---|
| N₀₇ | N₀₆ | N₀₅ | N₀₄ | N₀₃ | N₀₂ | N₀₁ | N₀₀ | oct2 |
| N₁₇ | N₁₆ | N₁₅ | N₁₄ | N₁₃ | N₁₂ | N₁₁ | N₁₀ | oct3 |
| N₂₇ | N₂₆ | N₂₅ | N₂₄ | N₂₃ | N₂₂ | N₂₁ | N₂₀ | oct4 |
| N₃₇ | N₃₆ | N₃₅ | N₃₄ | N₃₃ | N₃₂ | N₃₁ | N₃₀ | oct5 |

TABLE 3

| R | Serving Cell ID | | | | | BWP ID | | oct1 |
|---|---|---|---|---|---|---|---|---|
| R | R | R | R | S3 | S2 | S1 | S0 | oct2 |
| N₀₇ | N₀₆ | N₀₅ | N₀₄ | N₀₃ | N₀₂ | N₀₁ | N₀₀ | oct3 |
| N₁₇ | N₁₆ | N₁₅ | N₁₄ | N₁₃ | N₁₂ | N₁₁ | N₁₀ | oct4 |
| N₂₇ | N₂₆ | N₂₅ | N₂₄ | N₂₃ | N₂₂ | N₂₁ | N₂₀ | oct5 |
| N₃₇ | N₃₆ | N₃₅ | N₃₄ | N₃₃ | N₃₂ | N₃₁ | N₃₀ | oct6 |

In Tables 2 and 3, R represents reserved bits (bits); the Serving Cell ID is used to indicate the identity of the serving cell to which the MAC CE applies; the BWP ID is used to indicate the identity of the UL BWP applied by the MAC CE; Sᵢ is used to indicate the activation/deactivation status of the semi-persistent CSI report configuration in the CSI-ReportConfigToAddModList; N_{i, x} is used to indicate the activation/deactivation status of the semi-persistent CSI report SubConfiguration x in the CSI-ReportSubConfigList where CSI-ReportConfigId is i.

In some embodiments, Sᵢ is used to indicate the activation/deactivation status of the semi-persistent CSI report configuration within the CSI-ReportConfigToAddModList. So refers to the report configuration which includes PUCCH resources for SP CSI reporting in the indicated BWP and has the lowest CSI-ReportConfigId within the list with type set to semiPersistentOnPUCCH; Sᵢ refers to the reporting configuration which includes PUCCH resources for SP CSI reporting in the BWP and has the second lowest CSI ReportConfigId; and so on.

If the number of the reporting configurations within the list with type set to semi-PersistentOnPUCCH in the BWP is less than i+1, an MAC entity should ignore this Sᵢ field. When the Sᵢ field is set to 1, it is used to indicate that the corresponding semi-persistent CSI reporting configuration is activated; and when the Sᵢ field is set to 0, it is used to indicate that the corresponding semi-persistent CSI report configuration is deactivated. In some embodiments, if the Sᵢ field is set to 1, the UE may further check N_{i, x}. In some embodiments, if the Sᵢ field is set to 0, the UE does not check N_{i, x}, or considers that N_{i, x} is absent in this Sᵢ. In some embodiments, if the Sᵢ field is set to 0, the corresponding N_{i, x} field is not included. In some embodiments, if the Sᵢ field is set to 0, the corresponding N_{i, x} field is not included.

In some embodiments, N_{i, x} is used to indicate the activation/deactivation status of a semi-persistent CSI report SubConfiguration x within a CSI-ReportSubConfigList where CSI-ReportConfigId is i.

In a possible manner, N_{0, 0} refers to the report SubConfiguration which includes PUCCH resources for the activated SP CSI reporting in the indicated BWP and has the lowest csi-ReportSubConfigID within the list with type set to csi-ReportSubConfigList; N_{0, 1} refers to the reporting sub-configuration which includes PUCCH resources for the activated SP CSI reporting in the BWP and has the second lowest CSI ReportSubConfigID; and so on.

In a possible manner, N_{0, 0} refers to the reporting sub-configuration which includes PUCCH resources for the SP CSI reporting in the BWP and has the lowest CSI ReportSubConfigID in the list with type set to CSI ReportSubConfigList; No, 1 refers to the reporting sub-configuration which includes PUCCH resources for the SP CSI reporting in the BWP and has the second lowest CSI ReportSubConfigID; and so on.

In some embodiments, the MAC entity ignores the N_{i, x} field when the number of report configurations within the list with type set to csi-ReportSubConfigList in the BWP is greater than 4.

In some embodiments, when the number of report configurations within the list with type set to csi-ReportSubConfigList in the BWP is greater than 4, the MAC entity ignores the N_{i, x} field where x is greater than or equal to 4.

Optionally, when the number of report configurations within the list with type set to csi-ReportSubConfigList in the BWP is less than x+1, the MAC entity would ignore the N_{i, x} field.

When the N_{i, x} field is set to 1, it is used to indicate that the corresponding sub-configuration x in the semi-persistent CSI report i is activated; and when the N_{i, x} field is set to 0, it is used to indicate that the corresponding sub-configuration x in the semi-persistent CSI report i is deactivated

According to the above technical solution, it is described how a network indicates a reporting manner of a CSI report to UE through an MAC CE, and the design details of the MAC CE are described.

FIG. 5 illustrates another method of communication provided by an embodiment of the present disclosure, and the method may include:

S501, a terminal device receives fifth indication information from a network device, the fifth indication information is used to indicate a first operation, or the fifth indication information is used to indicate the first operation when a third condition is satisfied.

In this embodiment, the network device may transmit the fifth indication information to the terminal device, and correspondingly, the terminal device may receive the fifth indication information from the network device. The fifth indication information may be used to indicate the first operation, or the fifth indication information may be used to indicate the first operation when the third condition is satisfied.

In some embodiments, the fifth indication information may be, for example, Downlink Control Information (DCI) or MAC CE. The DCI may be, for example, DCI of a specific RNTI (e.g. NES RNTI) or a specific DCI format (e.g. DCI format 2_9).

In some embodiments, the first operation may include, for example, at least one of the following: a source cell of the terminal device entering Network Energy Saving (NES); the terminal device performing a Conditional Handover (CHO); the terminal device starting to perform CHO; and, the terminal device evaluating a CHO execution condition.

In some embodiments, in a case where the fifth indication information is used to indicate the first operation (that is, in a case where the terminal device receives the fifth indication information, or in a case where the terminal device receives the fifth indication information satisfying the third condition), the method may further include: the terminal device performs CHO based on the fifth indication information; or the terminal device starts to perform CHO based on the fifth indication information; or the terminal device evaluates a CHO execution condition based on the fifth indication information, or the terminal device determines/considers that a candidate target cell satisfies a CHO handover condition; or the terminal device determines/considers that the candidate target cell satisfies the CHO handover condition when a first CHO event (e.g., A3 or A4 or A5) is satisfied; or when the first CHO event is fulfilled, the terminal device determines/considers that the CHO execution condition is satisfied; or when the first CHO event is fulfilled, the terminal device determines/considers that the CHO event is fulfilled; or when the first CHO event is fulfilled, the terminal device determines/considers that the candidate target cell is a triggered cell.

In some embodiments, the method may further include: in a case where the fifth indication information is used to indicate the first operation, within a first duration, the terminal device performs any of the following operations: the terminal device does not expect to receive new fifth indication information; the terminal device does not expect to receive new fifth indication information that does not satisfy the third condition; when the terminal device receives the new fifth indication information, ignoring the new fifth indication information; and when the terminal device receives the new fifth indication information that does not satisfy the third condition, the new fifth indication information is ignored.

The first duration may be, for example, a timer duration.

In some embodiments, the start time of the first duration is a time when the terminal device receives the fifth indication information; or the start time of the first duration is a time when the terminal device receives the fifth indication information satisfying the third condition; or the start time of the first duration is a result of adding a first offset to the time at which the terminal device receives the fifth indication information (that is, the start time of the first duration=the time at which the terminal device receives the fifth indication information+the first offset); or the start time of the first duration is a result of adding the first offset to the time at which the terminal device receives the fifth indication information satisfying the third condition (that is, the start time of the first duration=the time at which the terminal device receives the fifth indication information satisfying the third condition+the first offset).

The first duration and/or the first offset, for example, may be predefined or preconfigured; or the first duration and/or the first offset may be configured by the network device; or the first duration and/or the first offset may be RRC configured; or the first duration and/or the first offset are included in the fifth indication information. In other words, the first duration is predefined, preconfigured, configured by the network device, configured based on RRC, or included in the fifth indication information; and the first offset is predefined, preconfigured, configured by the network device, configured based on RRC, or included in the fifth indication information.

In some embodiments, the method may further include: the network device transmits new fifth indication information to the terminal device, the new fifth indication information being used to indicate a third operation, or the new fifth indication information being used to indicate the third operation when the third condition is not satisfied.

In some embodiments, the third operation may include, for example, at least one of the following: a source cell of the terminal device leaving the NES; stopping performing the CHO; determining/considering that the candidate target cell does not satisfy the CHO handover condition; determining/considering that the CHO execution condition is not met; determining/deeming that the CHO event is not satisfied; determining/considering that the CHO execution condition is unavailable; determining/considering that the candidate target cell is not a triggered cell; and stopping the CHO evaluation.

In some embodiments, when the terminal device receives the new fifth indication information, or when the terminal device receives the new fifth indication information that does not satisfy the third condition, a second operation may be performed.

In some embodiments, the second operation may include, for example, at least one of the following: stopping performing the CHO; stopping the CHO evaluation; deleting a CHO configuration; indicating to the network device that the CHO is stopped; indicating to the network device that the handover stops; determining/considering that the candidate target cell does not satisfy the CHO handover condition; determining/deeming that the CHO execution condition is not met; determining/considering that the CHO event is not satisfied; determining/considering that the candidate target cell is not a triggered cell; and determining/considering that the source cell leaves the NES.

In some embodiments, the second operation described above is performed, for example, after the first duration. That is, after the first duration, when the terminal device receives new fifth indication information, or when the terminal device receives new fifth indication information that does not satisfy the third condition, the second operation may be performed.

In some embodiments, the third condition may include, for example: indicating a specific value (i.e., the first bit in the fifth indication information is set to a specific value). That is, when the fifth indication information (or the new fifth indication information) indicates a specific value, it means that the fifth indication information (or the new fifth indication information) satisfies the third condition, or otherwise, it means that the fifth indication information (or the new fifth indication information) does not satisfy the third condition.

As an example, the specific value may be, for example, 1. In this case, when the fifth indication information (or the new fifth indication information) indicates 1, it means that the fifth indication information (or the new fifth indication information) satisfies the third condition; and when the fifth indication information (or the new fifth indication information) indicates a non-specific value (for example, 0), it means that the fifth indication information (or the new fifth indication information) does not satisfy the third condition.

As another example, the specific value may be, for example, 0. In this case, when the fifth indication information (or the new fifth indication information) indicates 0, it means that the fifth indication information (or the new fifth indication information) satisfies the third condition; and when the fifth indication information (or the new fifth indication information) indicates a non-specific value (for example, 1), it means that the fifth indication information (or the new fifth indication information) does not satisfy the third condition.

In some embodiments, if a CHO event related to the NES and a CHO event unrelated to the NES are both configured, the terminal device performs CHO when one of the CHO events is satisfied. In some embodiments, the CHO event related to the NES and the CHO event unrelated to the NES are associated with the same CondReconfigId. That is, when the CHO event related to the NES (including that the fifth indication information or the fifth indication information satisfying the third condition is received) is satisfied, the terminal device considers a target candidate cell as the triggered cell, and/or performs CHO. When the NES-unrelated CHO event is fulfilled, or the NES-unrelated CHO event is fulfilled (regardless of whether the fifth indication information is received, or regardless of whether the fifth indication information satisfying the third condition is received), the terminal device considers the target candidate cell as the triggered cell, and/or performs CHO.

In an example, if one of the events associated to the measIds within condTriggerConfig for a target candidate cell within the stored condRRCReconfig is not associated (or configured) with nesEvent and fulfilled, and the other event associated to the measIds within condTriggerConfig for a target candidate cell within the stored condRRCReconfig is configured with nesEvent, then the following 1) or 2) is performed:
1) consider the target candidate cell within the stored condRRCReconfig, associated to that condReconfigId, as a triggered cell);
2) initiate the conditional reconfiguration execution.

In another example, if one of the events associated to the measIds within condTriggerConfig for a target candidate cell within the stored condRRCReconfig is configured with nesEvent and fulfilled, and the other event associated to the measIds within condTriggerConfig for a target candidate cell within the stored condRRCReconfig is not configured or associated with nesEvent, then the following 3) or 4) is performed:
3) consider the target candidate cell within the stored condRRCReconfig, associated to that condReconfigId, as a triggered cell;
4) initiate the conditional reconfiguration execution.

According to the method of this embodiment, it is described how a terminal device uses a CHO handover command.

It should be noted that the methods shown in FIGS. 2, 3, 4, and 5 in the embodiments of the present disclosure may be implemented alone, or two or more methods may be implemented in combination, and the embodiments of the present disclosure are not limited thereto.

The implementations of the present disclosure have been described in detail above with reference to the accompanying drawings, but the present disclosure is not limited to the specific details in the above-described embodiments. Within the scope of the technical concept of the present disclosure, various simple modifications can be made to the technical solutions of the present disclosure, and these simple modifications shall all fall within the scope of protection of the present disclosure. For example, various specific technical features described in the above Detailed Description can be combined in any suitable manner without contradiction, and various possible combinations will not be described separately in this disclosure in order to avoid unnecessary repetition. For example, various embodiments of the present disclosure may be combined arbitrarily, and as long as they do not violate the idea of the present disclosure, they should also be regarded as the disclosure of the present disclosure. For another example, on the premise that there is no conflict, each embodiment described in the present disclosure and/or the technical features in each embodiment can be arbitrarily combined with the prior art, and the technical solution obtained after the combination should also fall within the scope of protection of the present disclosure.

It should also be understood that in various method embodiments of the present disclosure, the size of the sequence number of the above-described processes does not mean the sequence of execution, and the sequence of execution of each process should be determined by its function and internal logic, and should not constitute any limitation on the implementation of the embodiments of the present disclosure. In addition, in the embodiments of the present disclosure, the terms “downlink”, “uplink”, and “sidelink” are used to indicate the transmission direction of signals or data, where “downlink” is used to indicate that the transmission direction of signals or data is a first direction from a site to UE of a cell, “uplink” is used to indicate that the transmission direction of signals or data is a second direction from the UE of the cell to the site, and “sidelink” is used to indicate that the transmission direction of signals or data is a third direction from UE 1 to UE 2. For example, “downlink signal” indicates that the transmission direction of signals is the first direction. In addition, in the embodiments of the present disclosure, the term “and/or” only describes an association relationship between associated objects, and indicates that there may be three types of relationships. Specifically, A and/or B may represent three cases which are A alone, A and B simultaneously, and B alone. In addition, the character “/” generally indicates that the related objects before and after are in an “or” relationship.

Based on the foregoing embodiments, embodiments of the present disclosure provide corresponding apparatuses of communication.

FIG. 6 is a schematic diagram of the structure and composition of an apparatus of communication provided by an embodiment of the present disclosure, and is applied to a terminal device. As shown in FIG. 6, the apparatus of communication 600 (hereinafter referred to as the apparatus 600 for short) includes:
a first obtaining unit 601, configured to obtain a first TA between the apparatus 600 and a first cell, the first TA being used for the apparatus 600 to perform uplink synchronization with the first cell, the first cell being a secondary cell with no SSB transmission.

In some embodiments, the first TA may be included in first indication information from a network device. The first indication information is a response to first request information, and the first request information is used to request for the first TA.

In some embodiments, the first indication information may be any of the following: a random access response; a TA command MAC CE; and a downlink message carrying the first TA.

In some embodiments, the first request information may be any of the following: a scheduling request; uplink control information; an uplink MAC CE; an uplink RRC message; an uplink resource of the first cell; and an uplink resource of a second cell, the second cell being a cell for the apparatus 600 to perform uplink synchronization with the first cell.

In some embodiments, the first TA may be obtained by a random access procedure. The random access procedure may be performed by the apparatus 600 in the first cell or a second cell; and the second cell is a cell for the apparatus 600 to perform uplink synchronization with the first cell.

In some embodiments, the first TA may be determined based on a second TA between the apparatus 600 and the second cell; and the second cell is a cell for the apparatus 600 to perform uplink synchronization with the first cell.

In some embodiments, the second TA may be included in second indication information from the network device, the second indication information is a response to the second request information, and the second request information is used to request for the second TA.

In some embodiments, the second indication information is any of the following: a random access response; a TA command MAC CE; and a downlink message carrying the second TA.

In some embodiments, the second request information may be any of the following: a scheduling request; uplink control information; an uplink MAC CE; an uplink RRC message; an uplink resource of the first cell; and an uplink resource of the second cell.

In some embodiments, the second TA may be obtained by a random access procedure. Here, the random access procedure may be performed by the apparatus 600 in the first cell or the second cell.

In some embodiments, the apparatus 600 may further include a second obtaining unit configured to obtain configuration information of a first reference signal, the first reference signal being a reference signal of the first cell or a reference signal of the second cell, and the first reference signal being used for performing a random access procedure.

In some embodiments, the type of the reference signal of the first cell may be a tracking reference signal or a channel state information reference signal; and the type of the reference signal of the second cell may be any one of: a synchronization signal block, a tracking reference signal, and a channel state information reference signal.

In some embodiments, the type of the first reference signal may be indicated by the network device.

In some embodiments, the second cell may be indicated by the network device, or the second cell may be preconfigured by the apparatus 600, or the second cell may be preconfigured by the network device, or the second cell may be predefined, or the second cell may be determined by apparatus 600.

In some embodiments, the second cell may be determined by the apparatus 600 based on first information from the network device, the first information including at least one of: location information of the network device; location information of a neighboring network device of the network device; location information of a third cell included in the network device, the third cell being the cell in which the apparatus 600 is located; location information of a cell adjacent to the third cell; co-located information between network devices; co-located information between cells; quasi-co-location information between reference signals; quasi-co-location information between channels; and positioning information.

In some embodiments, the second cell may be indicated by the network device through third indication information. The third indication information may include a frequency point and/or a cell identity of the second cell.

In some embodiments, the third indication information may be configured under a first condition.

In some embodiments, the first cell and the second cell belong to the same TA group and/or cell group.

In some embodiments, the TA group and/or the cell group may be determined by the network device based on second information, the second information including at least one of: a measurement result of the reference signal; positioning information; motion trajectory information of the apparatus 600; location information of the network device; location information of a neighboring network device of the network device; location information of a third cell included in the network device, the third cell being a cell in which the apparatus 600 is located; location information of a cell adjacent to the third cell; co-located information between network devices; and co-located information between cells.

In some embodiments, the second cell may be activated by the apparatus 600 as instructed by the network device, or the second cell may be activated by the apparatus 600 under a second condition.

In some embodiments, the second condition may include at least one of: a deactivation timer of the second cell timing out; the deactivation timer of the second cell needing to be started; the deactivation timer of the second cell needing to be restarted; obtaining indication information for indicating the second cell; obtaining a reference signal of the second cell; performing uplink synchronization or downlink synchronization with the first cell; obtaining a configuration of the first cell; the first cell being activated; and, the first cell needing to be activated.

In some embodiments, the first TA may be determined based on an uplink data signal of the first cell.

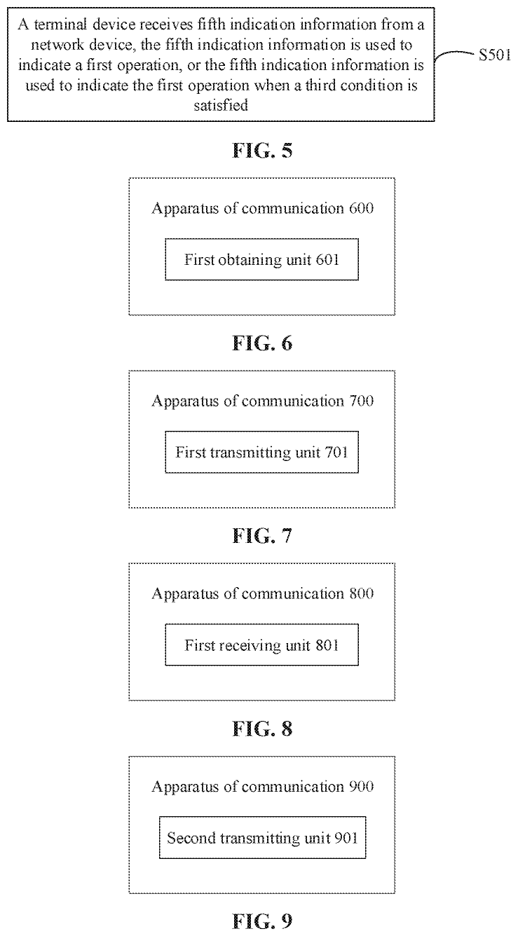

FIG. 7 is a second schematic structural diagram of an apparatus of communication according to an embodiment of the present disclosure, and is applied to a network device. As shown in FIG. 7, the apparatus of communication 700 (hereinafter referred to as the apparatus 700 for short) includes:

a first transmitting unit 701, configured to transmit fourth indication information to a terminal device, the fourth indication information including a first TA between the terminal device and a first cell, and/or a second TA between the terminal device and a second cell, the second cell being a cell for the terminal device to perform uplink synchronization with the first cell, the second TA being used to determine the first TA, and the first TA being used for the terminal device to perform uplink synchronization with the first cell, the first cell being a secondary cell with no SSB transmission.

In some embodiments, the fourth indication information may be a response to third request information for requesting for the first TA and/or the second TA.

In some embodiments, the fourth indication information may be any one of: a random access response; a TA command MAC CE; and a downlink message carrying the first TA and/or the second TA.

In some embodiments, the third request information may be any one of: a scheduling request; uplink control information; an uplink MAC CE; an uplink radio resource control message; an uplink resource of the first cell; and an uplink resource of the second cell.

In some embodiments, the fourth indication information may be a random access response transmitted to the terminal device in a random access procedure, the random access procedure being performed by the terminal device in the first cell or the second cell.

In some embodiments, the apparatus 700 may further include a second transmitting unit configured to transmit configuration information of a first reference signal, the first reference signal being a reference signal of the first cell or a reference signal of the second cell, the first reference signal being used to perform a random access procedure to the terminal device.

In some embodiments, the type of the reference signal of the first cell may be a tracking reference signal or a channel state information reference signal; and the type of the reference signal of the second cell may be any one of: a synchronization signal block, a tracking reference signal, and a channel state information reference signal.

In some embodiments, the type of the first reference signal may be indicated by apparatus 700.

In some embodiments, the second cell may be indicated by apparatus 700, or the second cell may be preconfigured by the terminal device, or the second cell may be preconfigured by the apparatus 700, or the second cell may be predefined, or the second cell may be determined by the terminal device.

In some embodiments, the second cell may be determined based on first information, the first information including at least one of: location information of the apparatus 700; location information of a network device adjacent to the apparatus 700; location information of a third cell included in the apparatus 700, the third cell being a cell in which the terminal device is located; location information of a cell adjacent to the third cell; co-located information between network devices; co-located information between cells; quasi-co-location information between reference signals; quasi-co-location information between channels; and positioning information.

In some embodiments, the second cell may be indicated by the apparatus 700 through third indication information, the third indication information including a frequency point and/or a cell identity of the second cell.

In some embodiments, the third indication information may be configured under a first condition.

In some embodiments, the first cell and the second cell belong to the same TA group and/or cell group.

In some embodiments, the TA group and/or the cell group may be determined by the apparatus 700 based on second information, the second information including at least one of: a measurement result of the reference signal; positioning information; motion trajectory information of the terminal device; location information of the apparatus 700; location information of a network device adjacent to apparatus 700; location information of a third cell included in the apparatus 700, the third cell being a cell in which the terminal device is located; location information of a cell adjacent to the third cell; co-located information between network devices; and co-located information between cells.

In some embodiments, the second cell is activated by the terminal device as instructed by the apparatus 700, or the second cell is activated by the terminal device under a second condition.

In some embodiments, the second condition may include at least one of: a deactivation timer of the second cell timing out; the deactivation timer of the second cell needing to be started; the deactivation timer of the second cell needing to be restarted; obtaining indication information for indicating the second cell; obtaining a reference signal of the second cell; performing uplink synchronization or downlink synchronization with the first cell; obtaining a configuration of the first cell; the first cell being activated; and, the first cell needing to be activated.

FIG. 8 is a third schematic diagram of the structure and composition of an apparatus of communication according to an embodiment of the present disclosure, and is applied to a terminal device. As shown in FIG. 8, the apparatus of communication 800 (hereinafter referred to as the apparatus 800 for short) includes:

a first receiving unit 801, configured to receive a reference signal of a second cell or a downlink data signal of a first cell, the reference signal or the downlink data signal being used for the apparatus 800 to perform downlink synchronization or downlink timing with the first cell, the second cell being a cell for the apparatus 800 to perform downlink synchronization or downlink timing with the first cell, and the first cell being a secondary cell with no SSB transmission.

In some embodiments, the type of the reference signal may be any one of: a synchronization signal block, a tracking reference signal, and a channel state information reference signal.

In some embodiments, at least part of configuration information of the reference signal may be indicated by the network device; and/or at least part of the configuration information of the reference signal may be read by the apparatus 800 from the second cell.

In some embodiments, when the reference signal is used for the apparatus 800 to perform downlink synchronization or downlink timing with the first cell, the type of the reference signal may be indicated by the network device.

In some embodiments, the second cell may be indicated by the network device, or the second cell may be preconfigured by the apparatus 800, or the second cell may be preconfigured by the network device, or the second cell may be predefined, or the second cell may be determined by the apparatus 800.

In some embodiments, the second cell may be determined based on first information, the first information including at least one of: location information of the network device; location information of a neighboring network device of the network device; location information of a third cell included in the network device, the third cell being a cell in which the apparatus 800 is located; location information of a cell adjacent to the third cell; co-located information between network devices; co-located information between cells; quasi-co-location information between reference signals; quasi-co-location information between channels; and positioning information.

In some embodiments, the second cell may be indicated by the network device through third indication information, the third indication information including a frequency point and/or a cell identity of the second cell.

In some embodiments, the third indication information may be configured under a first condition.

In some embodiments, the first cell and the second cell belong to the same TA group and/or cell group.

In some embodiments, the TA group and/or the cell group may be determined by the network device based on second information, the second information including at least one of: a measurement result of the reference signal; positioning information; motion trajectory information of the apparatus 800; location information of the network device; location information of a neighboring network device of the network device; location information of a third cell included in the network device, the third cell being a cell in which the apparatus 800 is located; location information of a cell adjacent to the third cell; co-located information between network devices; and co-located information between cells.

In some embodiments, the second cell may be activated by the apparatus 800 as instructed by the network device, or the second cell may be activated by the apparatus 800 under a second condition.

In some embodiments, the second condition may include at least one of: a deactivation timer of the second cell timing out; the deactivation timer of the second cell needing to be started; the deactivation timer of the second cell needing to be restarted; obtaining indication information for indicating the second cell; obtaining a reference signal of the second cell; performing uplink synchronization or downlink synchronization with the first cell; obtaining a configuration of the first cell; and, the first cell being activated or needing to be activated.

FIG. 9 is a fourth schematic diagram of the structure and composition of an apparatus of communication according to an embodiment of the present disclosure, and is applied to a network device. As shown in FIG. 9, the apparatus of communication 900 (hereinafter referred to as the apparatus 900 for short) includes:

a second transmitting unit 901, configured to transmit a reference signal of a second cell or a downlink data signal of a first cell to a terminal device, the reference signal or the downlink data signal being used for the terminal device to perform downlink synchronization or downlink timing with the first cell, the second cell being a cell for the terminal device to perform downlink synchronization or downlink timing with the first cell, and the first cell being a secondary cell with no SSB transmission.

In some embodiments, the type of the reference signal may be any one of: a synchronization signal block, a tracking reference signal, and a channel state information reference signal.

In some embodiments, at least part of configuration information of the reference signal for the terminal device to perform downlink synchronization or downlink timing with the first cell may be indicated by the apparatus 900; and/or at least part of the configuration information of the reference signal for the terminal device to perform downlink synchronization or downlink timing with the first cell may be read by the terminal device from the second cell.

In some embodiments, when the reference signal is used for the terminal device to perform downlink synchronization or downlink timing with the first cell, the type of the reference signal may be indicated by the apparatus 900.

In some embodiments, the second cell may be indicated by the apparatus 900, or the second cell may be preconfigured by the terminal device or apparatus 900, or the second cell may be predefined, or the second cell may be determined by the terminal device.

In some embodiments, the second cell may be determined based on first information, the first information including at least one of: location information of the apparatus 900; location information of a network device adjacent to the apparatus 900; location information of a third cell included in the apparatus 900, the third cell being a cell in which the terminal device is located; location information of a cell adjacent to the third cell; co-located information between network devices; co-located information between cells; quasi-co-location information between reference signals; quasi-co-location information between channels; and positioning information.

In some embodiments, the second cell may be indicated by the apparatus 900 through third indication information, the third indication information including a frequency point and/or a cell identity of the second cell.

In some embodiments, the third indication information may be configured under a first condition.

In some embodiments, the first cell and the second cell belong to the same TA group and/or cell group.

In some embodiments, the TA group and/or cell group may be determined by the apparatus 900 based on second information, the second information including at least one of: a measurement result of a reference signal; positioning information; motion trajectory information of the terminal device; location information of the apparatus 900; location information of a neighboring network device of apparatus 900; location information of a third cell included in the apparatus 900, the third cell being a cell in which the terminal device is located; location information of a cell adjacent to the third cell; co-located information between network devices; and co-located information between cells.

In some embodiments, the second cell may be activated by the terminal device as instructed by the apparatus 900, or the second cell may be activated by the terminal device under a second condition.

In some embodiments, the second condition may include at least one of: a deactivation timer of the second cell timing out; the deactivation timer of the second cell needing to be started; the deactivation timer of the second cell needing to be restarted; obtaining indication information for indicating the second cell; obtaining a reference signal of the second cell; performing uplink synchronization or downlink synchronization with the first cell; obtaining a configuration of the first cell; the first cell being activated; and, the first cell needing to be activated.

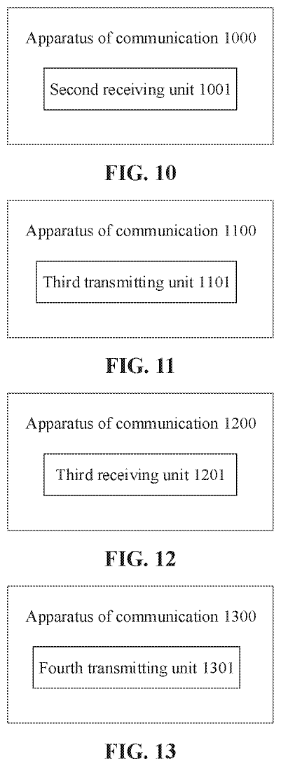

FIG. 10 is a fifth schematic diagram of the structure and composition of an apparatus of communication according to an embodiment of the present disclosure, and is applied to a terminal device. As shown in FIG. 10, the apparatus of communication 1000 (hereinafter referred to as the apparatus 1000 for short) includes:

a second receiving unit 1001, configured to receive a first MAC CE from a network device, the first MAC CE being configured to indicate a reporting manner of a first CSI report having a sub-reporting configuration.

In some embodiments, the first MAC CE may include indications or locations of a plurality of sub-reporting configurations corresponding to the first CSI report, and the first MAC CE may indicate the apparatus 1000 to report the first CSI report when the indication or location of any of the sub-reporting configurations is set to activated.

In some embodiments, in a case where the first MAC CE indicates the apparatus 1000 to report the first CSI report, among the indications or locations of the plurality of sub-reporting configurations corresponding to the first CSI report, the number of indications or locations of the sub-reporting configurations set to activated is greater than 1.

In some embodiments, for each of the plurality of sub-reporting configurations corresponding to the first CSI report, when the indication or location of the sub-reporting configuration is set to activated, the first MAC CE is further configured to indicate the apparatus 1000 to report a sub-report corresponding to the sub-reporting configuration in the first CSI report.

In some embodiments, the first MAC CE may be further used to indicate a reporting manner of a second CSI report with no sub-reporting configuration.

In some embodiments, the first MAC CE may include indications or locations of a plurality of sub-reporting configurations corresponding to the second CSI report, and the first MAC CE may indicate the apparatus 1000 to report the second CSI report when the indications or locations of any of the sub-reporting configurations is set to activated.

In some embodiments, in a case where the first MAC CE indicates the apparatus 1000 to report the second CSI report, among the indications or locations of the plurality of sub-reporting configurations corresponding to the second CSI report, the number of indications or locations of the sub-reporting configurations set to activated is 1.

In some embodiments, the length of the first MAC CE may be fixed.

In some embodiments, the first MAC CE is not used to indicate the reporting manner of the second CSI report with no sub-reporting configuration.

In some embodiments, the second CSI report may be indicated by a second MAC CE.

In some embodiments, the length of the first MAC CE may be fixed or variable.

FIG. 11 is a sixth schematic diagram of the structure and composition of an apparatus of communication according to an embodiment of the present disclosure, and is applied to a network device. As shown in FIG. 11, the apparatus of communication 1100 (hereinafter referred to as the apparatus 1100 for short) includes:

a third transmitting unit 1101, configured to transmit, to a terminal device, a first MAC CE for indicating a reporting manner of a first CSI report having a sub-reporting configuration.

In some embodiments, the first MAC CE may include indications or locations of a plurality of sub-reporting configurations corresponding to the first CSI report, and the first MAC CE may indicate the terminal device to report the first CSI report when any of the indications or locations of the sub-reporting configurations is set to activated.

In some embodiments, when the first MAC CE indicates the terminal device to report the first CSI report, among the indications or locations of the plurality of sub-reporting configurations corresponding to the first CSI report, the number of indications or locations of the sub-reporting configurations set to activated is greater than 1.

In some embodiments, for each of the plurality of sub-reporting configurations corresponding to the first CSI report, the first MAC CE is further configured to indicate the terminal device to report a sub-report corresponding to the sub-reporting configuration in the first CSI report when the indication or location of the sub-reporting configuration is set to activated.

In some embodiments, the first MAC CE is further used to indicate a reporting manner of a second CSI report with no sub-reporting configuration.

In some embodiments, the first MAC CE may include indications or locations of a plurality of sub-reporting configurations corresponding to the second CSI report, and in a case where the indication or location of any of the sub-reporting configurations is set to activated, the first MAC CE may indicate the terminal device to report the second CSI report.

In some embodiments, when the first MAC CE indicates the terminal device to report the second CSI report, among the indications or locations of the plurality of sub-reporting configurations corresponding to the second CSI report, the number of indications or locations of the sub-reporting configurations set to activated is 1.

In some embodiments, the length of the first MAC CE may be fixed.

In some embodiments, the first MAC CE is not used to indicate the reporting manner of the second CSI report with no sub-reporting configuration.

In some embodiments, the second CSI report may be indicated by a second MAC CE.

In some embodiments, the length of the first MAC CE may be fixed or variable.

FIG. 12 is a seventh schematic diagram of the structure and composition of an apparatus of communication according to an embodiment of the present disclosure, and is applied to a terminal device. As shown in FIG. 12, the apparatus of communication 1200 (hereinafter referred to as the apparatus 1200 for short) includes:
a third receiving unit 1201, configured to receive fifth indication information from a network device, the fifth indication information being used to indicate a first operation, or the fifth indication information being used to indicate the first operation when a third condition is satisfied. The first operation includes at least one of the following: a source cell of the apparatus 1200 entering NES; the apparatus 1200 performing CHO; the apparatus 1200 starting to perform CHO; and the apparatus 1200 evaluating a CHO execution condition.

In some embodiments, the apparatus 1200 may further include: a first processing unit, configured to: when the fifth indication information is used to indicate the first operation, perform CHO based on the fifth indication information; start to perform CHO based on the fifth indication information; or evaluate a CHO execution condition based on the fifth indication information; or determine that a candidate target cell satisfies a CHO handover condition; or when a first CHO event is fulfilled, determine that the candidate target cell satisfies the CHO handover condition; or, when the first CHO event is fulfilled, determine that the CHO execution condition is satisfied; or determine that the CHO event is fulfilled when the first CHO event is fulfilled; or when the first CHO event is fulfilled, determine that the candidate target cell is the triggered cell.

In some embodiments, the apparatus 1200 may further include: a second processing unit, configured to: in a case where the fifth indication information is used to indicate the first operation, not expect to receive new fifth indication information within a first duration; or not expect to receive new fifth indication information that does not satisfy a third condition within the first duration; or in a case where the apparatus 1200 receives the new fifth indication information within the first duration, ignore the new fifth indication information; or in a case where the apparatus 1200 receives the new fifth indication information that does not satisfy the third condition in the first duration, ignore the new fifth indication information.

In some embodiments, the start time of the first length of time is a time when the apparatus 1200 receives the fifth indication information, or the start time of the first duration is a time when the apparatus 1200 receives the fifth indication information satisfying the third condition, or the start time of the first length of time is a result of adding a first offset to the time when the apparatus 1200 receives the fifth indication information, or the start time of the first length of time is a result of adding a first offset to the time at which the apparatus 1200 receives the fifth indication information satisfying the third condition.

In some embodiments, the first duration may be predefined, preconfigured, configured by the network device, configured based on RRC, or included in the fifth indication information; and the first offset may be predefined, preconfigured, configured by network device, configured based on RRC, or included in the fifth indication information.

In some embodiments, the apparatus 1200 may further include: a third processing unit, configured to: in a case where the apparatus 1200 receives the new fifth indication information, or in a case where the apparatus 1200 receives the new fifth indication information that does not satisfy the third condition, perform a second operation, the second operation including at least one of: stopping performing the CHO; stopping the CHO evaluation; deleting a CHO configuration; indicating to the network device that the CHO is stopped; indicating to the network device that the handover is stopped; determining that the candidate target cell does not satisfy the CHO handover condition; determining that the CHO execution condition is not satisfied; determining that the CHO event is not fulfilled; determining that the candidate target cell is not a triggered cell; and determining that the source cell leaves the NES.

In some embodiments, the apparatus 1200 may further include: a fourth processing unit, configured to: after the first duration, in a case where the apparatus 1200 receives the new fifth indication information, or in a case where the apparatus 1200 receives the new fifth indication information that does not satisfy the third condition, perform a second operation, the second operation including at least one of: stopping performing the CHO; stopping the CHO evaluation; deleting a CHO configuration; indicating to the network device that the CHO is stopped; indicating to the network device that the handover is stopped; determining that the candidate target cell does not satisfy the CHO handover condition; determining that the CHO execution condition is not satisfied; determining that the CHO event is not fulfilled; determining that the candidate target cell is not a triggered cell; and determining that the source cell leaves the NES.

In some embodiments, the new fifth indication information is used to indicate the third operation, or the new fifth indication information is used to indicate a third operation in a case where the third condition is not met. The third operation includes at least one of: a source cell of the apparatus 1200 leaving the NES; stopping performing the CHO; determining that the candidate target cell does not satisfy the CHO handover condition; determining that the CHO execution condition is not satisfied; determining that the CHO event is not fulfilled; determining that the CHO execution condition is not available; determining that the candidate target cell is not a triggered cell; and stopping the CHO evaluation.

In some embodiments, the third condition may include that the first bit in the fifth indication information is set to a specific value.

FIG. 13 is an eighth schematic diagram of the structure and composition of an apparatus of communication according to an embodiment of the present disclosure, and is applied to a network device. As shown in FIG. 13, the apparatus of communication 1300 (hereinafter referred to as the apparatus 1300 for short) includes:
a fourth transmitting unit 1301, configured to transmit fifth indication information to a terminal device, the fifth indication information being used to indicate a first operation, or the fifth indication information being used to indicate the first operation when a third condition is satisfied. The first operation includes at least one of the following: a source cell of the terminal device entering NES; the terminal device performing CHO; the terminal device starting to perform CHO; and, the terminal device evaluating a CHO execution condition.

In some embodiments, the apparatus 1200 may further include: a fifth transmitting unit, configured to transmit new fifth indication information to the terminal device, the new fifth indication information being used to indicate a third operation, or the new fifth indication information is used to indicate the third operation when a third condition is not satisfied. The third operation includes at least one of the following: a source cell of the terminal device leaving NES; stopping performing CHO; determining that a candidate target cell does not satisfy a CHO handover condition; determining that a CHO execution condition is not satisfied; determining that a CHO event is not fulfilled; determining that a CHO execution condition is not available; determining that the candidate target cell is not a triggered cell; and stopping CHO evaluation.

In some embodiments, the third condition includes that the first bit in the fifth indication information is set to a specific value.

Those skilled in the art should understand that the related description of the above-described apparatuses of communication according to the embodiments of the present disclosure can be understood with reference to the related description of the methods of communication according to the embodiments of the present disclosure.

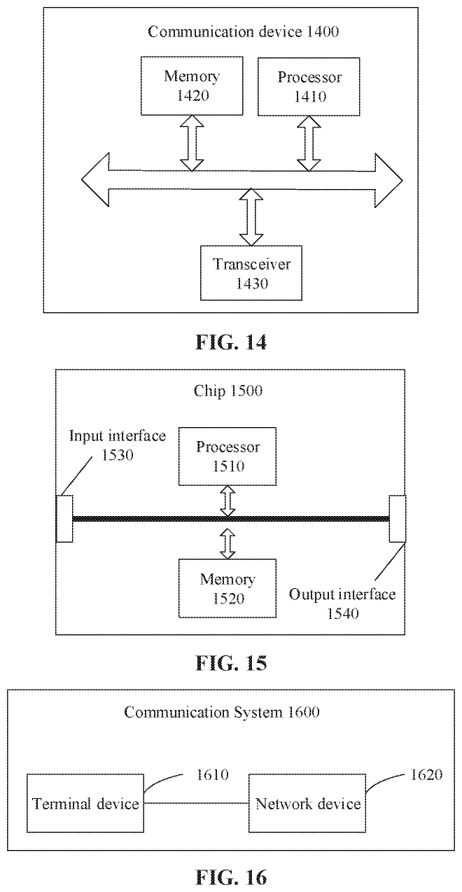

FIG. 14 is a schematic structural diagram of a communication device 1400 according to an embodiment of the present disclosure. The communication device may be a terminal device or a network device. The communication device 1400 illustrated in FIG. 14 includes a processor 1410, and the processor 1410 may call and run a computer program from a memory to implement the methods in the embodiments of the present disclosure.

Optionally, as shown in FIG. 14, the communication device 1400 may further include a memory 1420. The processor 1410 may call and run a computer program from the memory 1420 to implement the methods in the embodiments of the present disclosure.

The memory 1420 may be a separate device independent of the processor 1410 or may be integrated in the processor 1410.

Optionally, as shown in FIG. 14, the communication device 1400 may further include a transceiver 1430, and the processor 1410 may control the transceiver 1430 to communicate with other devices, specifically, may transmit information or data to other devices, or receive information or data from other devices.

Here, the transceiver 1430 may include a transmitter and a receiver. The transceiver 1430 may further include antennas, and the number of antennas may be one or more.

Optionally, the communication device 1400 may specifically be the network device according to the embodiments of the present disclosure, and the communication device 1400 may implement corresponding processes implemented by the network device in each method according to the embodiments of the present disclosure, and will not be described herein for the sake of brevity.

Optionally, the communication device 1400 may specifically be the terminal device according to the embodiments of the present disclosure, and the communication device 1400 may implement corresponding processes implemented by the terminal device in each method according to the embodiments of the present disclosure, and will not be described herein for the sake of brevity.

Optionally, the transceiver 1430 may be the first obtaining unit 601 in the apparatus 600, the first transmitting unit 701 in the apparatus 700, the first receiving unit 801 in the apparatus 800, the second transmitting unit 901 in the apparatus 900, the second receiving unit 1001 in the apparatus 1000, the third transmitting unit 1101 in the apparatus 1100, the third receiving unit 1201 in the apparatus 1200, or the fourth transmitting unit 1301 in the apparatus 1300.

Alternatively, the processor 1410 may be, for example, the first obtaining unit 601 in the apparatus 600.

FIG. 15 is a schematic structural diagram of a chip according to an embodiment of the present disclosure. The chip 1500 shown in FIG. 15 includes a processor 1510, which may call and run a computer program from a memory to implement the methods in the embodiments of the present disclosure.

Optionally, as shown in FIG. 15, the chip 1500 may further include a memory 1520. The processor 1510 may call and run a computer program from the memory 1520 to implement the methods in the embodiments of the present disclosure.

The memory 1520 may be a separate device independent of the processor 1510 or may be integrated in the processor 1510.

Optionally, the chip 1500 may further include an input interface 1530. The processor 1510 may control the input interface 1530 to communicate with other devices or chips, specifically, may acquire information or data from other devices or chips.

Optionally, the chip 1500 may further include an output interface 1540. The processor 1510 may control the output interface 1540 to communicate with other devices or chips, specifically, may output information or data to other devices or chips.

Optionally, the chip can be applied to the network device in the embodiments of the present disclosure, and the chip can implement the corresponding process implemented by the network device in each method of the embodiments of the present disclosure, and will not be repeated here for the sake of brevity.

Optionally, the chip can be applied to the terminal device in the embodiments of the present disclosure, and the chip can implement the corresponding process implemented by the terminal device in each method of the embodiments of the present disclosure, and will not be repeatedly described here for the sake of brevity.

It should be understood that the chip mentioned in the embodiments of the present disclosure may also be referred to as a system-level chip, a system chip, a chip system, a system-on-chip, or the like.

An embodiment of the present disclosure also provides a computer storage medium, which has stored thereon one or more programs that can be executed by one or more processors to implement the methods in the embodiments of the present disclosure.

FIG. 16 is a schematic block diagram of a communication system 1600 according to an embodiment of the present disclosure. As shown in FIG. 16, the communication system 1600 includes a terminal device 1610 and a network device 1620.

The terminal device 1610 may be used to implement the corresponding functions implemented by the terminal device in the above-described methods, and the network device 1620 may be used to implement the corresponding functions implemented by the network device in the above-described methods, and the description thereof will not be described herein for the sake of brevity.

It should be understood that the processor of the embodiments of the present disclosure may be an integrated circuit chip having signal processing capabilities. In the implementation process, the steps of the above-described method embodiments may be completed by integrated logic circuits of hardware in the processor or instructions in the form of software. The processor described above may be a general-purpose processor, a Digital Signal Processor (DSP), an Application Specific Integrated Circuit (ASIC), an off-the-shelf Field Programmable Gate Array (FPGA) or other programmable logic device, a discrete gate or transistor logic device, or a discrete hardware component. The methods, steps, and logical block diagrams described in the embodiments of the present disclosure may be implemented or executed. The general-purpose processor may be a microprocessor or the processor may be any conventional processor or the like. The steps of the methods described in connection with the embodiments of the present disclosure may be directly executed by a hardware decoding processor, or may be executed by combining hardware and software modules in the decoding processor. The software module may be located in a storage medium mature in the art, such as random access memory, flash memory, read-only memory, programmable read-only memory, or electrically erasable and writable programmable memory, registers, etc. The storage medium is located in the memory, and the processor may read information from the memory, and combine its hardware to complete the steps of the above methods.

It is understood that the memory in the embodiments of the present disclosure may be a volatile memory or a non-volatile memory, or may include both volatile and non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which serves as an external cache. By way of example, but not limitation, many forms of RAM are available, such as Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), and Direct Rambus RAM (DR RAM). It should be noted that the memory of the systems and methods described herein is intended to include, but is not limited to, these and any other suitable type of memory.

It should be understood that the above memory is illustrative but not limiting, for example, the memory in the embodiments of the present disclosure may also be a static random access memory (SRAM), a dynamic random access memory (DRAM), a synchronous dynamic random access memory (SDRAM), a double data rate synchronous dynamic random access memory (DDR SDRAM), an enhanced SDRAM (ESDRAM), a synch link dynamic random access memory (SLDRAM), a Direct Rambus RAM (DR RAM), and the like. That is, the memory in the embodiments of the present disclosure is intended to include, but is not limited to, these and any other suitable type of memory.

Embodiments of the present disclosure also provide a computer-readable storage medium for storing a computer program.

Optionally, the computer-readable storage medium may be applied to the network device in the embodiments of the present disclosure, and the computer program may cause the computer to execute the corresponding process implemented by the network device in each method in the embodiments of the present disclosure, and the description thereof will not be repeated here for the sake of brevity.

Optionally, the computer-readable storage medium may be applied to the terminal device in the embodiments of the present disclosure, and the computer program may cause the computer to execute the corresponding process implemented by the terminal device in each method of the embodiments of the present disclosure, and the description thereof will not be repeated here for the sake of brevity.

Embodiments of the present disclosure also provide a computer program product including computer program instructions.

Optionally, the computer program product may be applied to the network device in the embodiments of the present disclosure, and the computer program instructions may cause the computer to execute the corresponding process implemented by the network device in each method in the embodiments of the present disclosure, and the description thereof is not repeated here for the sake of brevity.

Optionally, the computer program product may be applied to the terminal device in the embodiments of the present disclosure, and the computer program instructions may cause the computer to execute the corresponding process implemented by the terminal device in each method of the embodiments of the present disclosure, and the description thereof will not be repeated here for the sake of brevity.

Embodiments of the present disclosure also provide a computer program.

Optionally, the computer program may be applied to the network device in the embodiments of the present disclosure, and when the computer program is run on a computer, the computer may execute the corresponding process implemented by the network device in each method of the embodiments of the present disclosure, and the description thereof is not repeated here for the sake of brevity.

Optionally, the computer program may be applied to the terminal device in the embodiments of the present disclosure, and when the computer program is run on a computer, the computer may execute the corresponding process implemented by the terminal device in each method of the embodiments of the present disclosure, and the description thereof is not repeated here for the sake of brevity.

Those of ordinary skill in the art will appreciate that the elements and algorithmic steps of the various examples described in connection with the embodiments herein can be implemented in electronic hardware, or a combination of computer software and electronic hardware. Whether these functions are performed in hardware or software depends on the specific application and design constraints of the technical solution. Those skilled in the art may use different methods for implementing the described functions for each particular application, and such implementations should not be considered beyond the scope of the present disclosure.

Those skilled in the art can clearly understand that for convenience and conciseness of the description, the specific working processes of the systems, devices, and units described above may refer to the corresponding processes in the aforementioned method embodiments, and will not be repeatedly described herein.

In several embodiments provided herein, it should be understood that the described system, apparatuses, and methods may be implemented in other ways. For example, the apparatus embodiments described above are merely schematic, for example, the division of units is only a logical functional division, and there may be other division methods in actual implementation, for example, multiple units or components may be combined or integrated into another system, or some features may be ignored or not implemented. In addition, the coupling or direct coupling or communication connection between each other shown or discussed may be an indirect coupling or communication connection through some interface, device or unit, which may be electrical, mechanical or the like.

The units described as separate units may be or may not be physically separate, and the units displayed as units may be or may not be physical units, that is, they may be located in one place or may be distributed over a plurality of network units. Some or all of the units may be selected according to actual needs to achieve the purpose of the solution of the embodiments.

In addition, each functional unit in each embodiment of the present disclosure may be integrated in one processing unit, each unit may be physically present alone, or two or more units may be integrated in one unit.

The functions may be stored in a computer-readable storage medium if implemented in the form of software functional units and sold or used as independent products. Based on this understanding, the technical solution of the present disclosure essentially or partially contributing to the related art or a part of the technical solution may be embodied in the form of a software product, which is stored in a storage medium and includes several instructions for causing a computer device (which may be a personal computer, a server, or a network device, etc.) to perform all or part of the steps of the methods described in various embodiments of the present disclosure. The storage medium includes a USB disk, a removable hard disk, a Read-Only Memory (ROM), a Random Access Memory (RAM), a magnetic disk, or an optical disk that can store a program code.

The above are merely specific embodiments of the present disclosure, and the scope of protection of the present disclosure is not limited thereto. Any person skilled in the art can easily think of changes or substitutions within the technical scope described in the present disclosure, and should be covered within the scope of protection of the present disclosure. Therefore, the scope of protection of the present disclosure should be based on the scope of protection of the claims.

1. A method of communication, comprising:
receiving, by a terminal device, a first media access control control element (MAC CE) from a network device, the first MAC CE being configured to indicate a reporting manner of a first CSI report having a sub-reporting configuration.

2. The method of claim 1, wherein the reporting manner is an activation mode.

3. The method of claim 1, wherein
the first MAC CE comprises indications or locations of a plurality of sub-reporting configurations corresponding to the first CSI report, and in a case where the indication or location of any one of the plurality of sub-reporting configurations is set to activated, the first MAC CE indicates the terminal device to report the first CSI report.

4. The method of claim 3, wherein
in the case where the first MAC CE indicates the terminal device to report the first CSI report, among the indications or locations of the plurality of sub-reporting configurations corresponding to the first CSI report, a number of indications or locations of the sub-reporting configurations set to activated is greater than 1.

5. The method of claim 3, wherein
for each of the plurality of sub-reporting configurations corresponding to the first CSI report, when the indication or location of the sub-reporting configuration is set to activated, the first MAC CE is further configured to indicate the terminal device to report a sub-report corresponding to the sub-reporting configuration in the first CSI report.

6. The method of claim 1, wherein
the first MAC CE is further configured to indicate a reporting manner of a second CSI report with no sub-reporting configuration,
wherein the first MAC CE comprises indications or locations of a plurality of sub-reporting configurations corresponding to the second CSI report, and in a case where the indication or location of any one of the plurality of sub-reporting configurations is set to activated, the first MAC CE indicates the terminal device to report the second CSI report,
wherein in the case where the first MAC CE indicates the terminal device to report the second CSI report, among the plurality of indications or locations of sub-reporting configurations corresponding to the second CSI report, a number of indications or locations of sub-reporting configurations set to activated is 1,
wherein the first MAC CE has a fixed length.

7. The method of claim 1, wherein the first MAC CE is not used to indicate a reporting manner of a second CSI report with no sub-reporting configuration.

8. The method of claim 7, wherein the second CSI report is indicated by a second MAC CE.

9. The method of claim 8, wherein the second MAC CE is an existing MAC CE, wherein the existing MAC CE is SP CSI reporting on PUCCH Activation/Deactivation MAC CE; and
the second MAC CE is configured to indicate at least the reporting manner of the second CSI report with no sub-reporting configuration.

10. The method of claim 7, wherein the first MAC CE has a fixed or variable length.

11. The method of claim 10, wherein
when a value of an indication or location of a sub-reporting configuration is set to a first specific value, it indicates that the indication or location of the sub-reporting configuration is set to activated; or, when the value of the indication or location of the sub-reporting configuration is set to a second specific value, it indicates that the indication or location of the sub-reporting configuration is set to deactivated, wherein the location is a bitmap location,
wherein the first MAC CE is identified using a new Logical Channel ID (LCID), the new LCID an E-LCID.

12. A method of communication, comprising:
transmitting, by a network device, a first media access control control element (MAC CE) to a terminal device, wherein the first MAC CE is configured to indicate a reporting manner of a first CSI report having a sub-reporting configuration.

13. An apparatus of communication, comprising: a transceiver; and a processor, connected to the transceiver and configured to control the transceiver to communicate with other devices,
wherein the transceiver is configured to receive a first medium access control control element (MAC CE) from a network device, the first MAC CE being configured to indicate a reporting manner of a first SCI report having a sub-configuration.

14. The apparatus of claim 13, wherein
the first MAC CE comprises indications or locations of a plurality of sub-reporting configurations corresponding to the first CSI report, and in a case where the indication or location of any one of the plurality of sub-reporting configurations is set to activated, the first MAC CE indicates the terminal device to report the first CSI report.

15. The apparatus of claim 14, wherein
in the case where the first MAC CE indicates the terminal device to report the first CSI report, among the indications or locations of the plurality of sub-reporting configurations corresponding to the first CSI report, a number of indications or locations of the sub-reporting configurations set to activated is greater than 1.

16. The apparatus of claim 14, wherein
for each of the plurality of sub-reporting configurations corresponding to the first CSI report, when the indication or location of the sub-reporting configuration is set to activated, the first MAC CE is further configured to indicate the terminal device to report a sub-report corresponding to the sub-reporting configuration in the first CSI report.

17. The apparatus of claim 13, wherein the first MAC CE is not used to indicate a reporting manner of a second CSI report with no sub-reporting configuration.

18. The apparatus of claim 17, wherein the second CSI report is indicated by a second MAC CE.

19. The apparatus of claim 17, wherein the first MAC CE has a fixed or variable length.

20. An apparatus of communication, comprising: a transceiver; and a processor, connected to the transceiver and configured to control the transceiver to perform the method of claim 12.
